(19) United States
(12) Patent Application Publication
(10) Pub. No.: US 2022/0327496 A1
(43) Pub. Date: Oct. 13, 2022

(54) INFORMATION PRESENTATION DEVICE, OPERATION METHOD OF INFORMATION PRESENTATION DEVICE, AND OPERATION PROGRAM OF INFORMATION PRESENTATION DEVICE

(71) Applicant: FUJIFILM Corporation, Tokyo (JP)

(72) Inventor: Toshihiko KAKU, Saitama (JP)

(73) Assignee: FUJIFILM Corporation, Tokyo (JP)

(21) Appl. No.: 17/715,078

(22) Filed: Apr. 7, 2022

(30) Foreign Application Priority Data
Apr. 13, 2021 (JP) 2021-067966

(51) Int. Cl. G06Q 10/10

(52) U.S. Cl. CPC G06Q 10/1095

(57) ABSTRACT

A distribution control unit of a CPU of an event reservation server distributes event information to a user terminal to present an event to a user. A request reception unit receives a participation application request from the user terminal to receive a participation application for the event by the user. A request reception unit receives the participation application request related to the participation application by the user for an event different from the application event before a start of the application event, as related information related to an application event that is the event in which the user applies for participation. In this case, an information acquisition unit acquires route information between a place of the application event and a place of the different event as first additional information. The distribution control unit distributes the route information to the user terminal to present the route information to the user.

### CROSS-REFERENCE TO RELATED APPLICATIONS

The present application claims priority under 35 U.S.C. §119 to Japanese Patent Application No., 2021-067966 filed on Apr. 13, 2021. The above application is hereby expressly incorporated by reference, in its entirety, into the present application.

### BACKGROUND

### 1. Technical Field

The technique of the present disclosure relates to an information presentation device, an operation method of the information presentation device, and an operation program of the information presentation device.

### 2. Description of the Related Art

Information that is appropriate for a user is presented. For example, JP2019-193037A describes a technique of presenting an event based on a residential area of the user to the user and of presenting, in a case where the user registers the presented event as a schedule, additional information according to the registered event to the user. In JP2019-193037A, a Bon dance festival is exemplified as the event based on the residential area of the user, and information on recruitment of volunteers for the Bon dance festival, information on a program of a Bon dance course, and the like are exemplified as the additional information on the event.

### SUMMARY

The additional information presented to the user in JP2019-193037A is only information according to the event registered by the user. Therefore, a range of the information is narrow and usefulness is low.

One embodiment according to the technique of the present disclosure provides an information presentation device, an operation method of the information presentation device, and an operation program of the information presentation device capable of presenting a wider range of useful information to a user.

An information presentation device according to the present disclosure comprises a processor, and a memory connected to or built into the processor. The processor presents an event to a user, receives a participation application for the event by the user, acquires first additional information according to related information, which is related to an application event that is the event in which the user applies for participation, in a case where the related information is received from reception of the participation application for the application event to a start of the application event, and presents the first additional information to the user.

The related information may be at least one of information related to a participation application by the user for an event different from the application event before the start of the application event or a weather forecast for a place of the application event on an event start day.

The first additional information may include at least one of information related to a route between the place of the application event and a place of the different event or information on an alternative event in a case where the weather forecast is unsuitable for the application event.

The event may be selected based on an image owned by the user.

The processor may present second additional information according to the application event to the user.

The second additional information may include information on an item necessary for the application event.

The second additional information may include information on a different event at a place within a distance range set in advance based on the place of the application event.

The second additional information may include information on a place of meal where taking a meal is possible before or after the application event.

The second additional information may include information on a way of enjoying the application event.

The second additional information may include information on a recommended imaging point in the application event.

The processor may present a reminder of the application event to the user.

The processor may present, to the user, notification to urge the user to upload an image captured in the application event after the application event is executed.

A schedule table including the information on the application event may be presented to the user.

A free time may be selectable in the schedule table, and making a request for presentation of a different event that is executable in the selected free time may be possible.

An operation method of an information presentation device according to the present disclosure includes presenting an event to a user, receiving a participation application for the event by the user, acquiring first additional information according to related information, which is related to an application event that is the event in which the user applies for participation, in a case where the related information is received from reception of the participation application for the application event to a start of the application event, and presenting the first additional information to the user.

An operation program of an information presentation device according to the present disclosure causes a computer to execute a process including presenting an event to a user, receiving a participation application for the event by the user, acquiring first additional information according to related information, which is related to an application event that is the event in which the user applies for participation, in a case where the related information is received from reception of the participation application for the application event to a start of the application event, and presenting the first additional information to the user.

According to the technique of the present disclosure, it is possible to provide the information presentation device, the operation method of the information presentation device, and the operation program of the information presentation device capable of presenting a wider range of useful information to the user.

### BRIEF DESCRIPTION OF THE DRAWINGS

Exemplary embodiments according to the technique of the present disclosure will be described in detail based on the following figures, wherein:

FIG. 1 is a diagram showing an event reservation system;

FIG. 2 is a diagram showing information exchanged between an event reservation server and a user terminal;

FIG. 3 is a diagram showing an inside of an event information DB and a content of event information;

FIG. 4 is a block diagram showing a computer constituting the event reservation server and the user terminal;

FIG. 5 is a block diagram showing a processing unit of a CPU of the event reservation server;

FIG. 6 is a diagram showing processing in a case where an event information distribution request from the user terminal is received;

FIG. 7 is a diagram showing processing in a case where a participation application request for a first event is received from the user terminal;

FIG. 8 is a diagram showing processing in a case where the participation application request for a second event is received from the user terminal;

FIG. 9 is a diagram showing processing in a case where the participation application request for a third event is received from the user terminal;

FIG. 10 is a block diagram showing a processing unit of a CPU of the user terminal;

FIG. 11 is a diagram showing a main screen;

FIG. 12 is a diagram showing the main screen on which route information is displayed;

FIG. 13 is a flowchart showing a processing procedure of the event reservation server;

FIG. 14 is a flowchart showing a processing procedure of the event reservation server;

FIG. 15 is a diagram showing the event reservation system according to a 1_2 embodiment;

FIG. 16 is a diagram showing processing in a case where a weather forecast distribution request from the user terminal is received;

FIG. 17 is a diagram showing processing in a case where the weather forecast distribution request from the user terminal is received;

FIG. 18 is a diagram showing the main screen according to the 1_2 embodiment;

FIG. 19 is a diagram showing a weather forecast display screen;

FIG. 20 is a flowchart showing a processing procedure of the event reservation server according to the 1_2 embodiment;

FIG. 21 is a diagram showing the event reservation system according to a second embodiment;

FIG. 22 is a diagram showing a state where an event is selected based on an image owned by the user and an attribute of the user;

FIG. 23 is a diagram showing a state where an event is selected based on an image owned by the user and the attribute of the user;

FIG. 24 is a diagram showing the main screen according to the second embodiment;

FIG. 25 is a diagram showing the event information according to a 3_1 embodiment;

FIG. 26 is a diagram showing the main screen according to the 3_1 embodiment;

FIG. 27 is a diagram showing a necessary item display screen;

FIG. 28 is a diagram showing processing in a case where a different event information distribution request from the user terminal is received in a 3_2 embodiment;

FIG. 29 is a diagram showing the main screen in the 3_2 embodiment;

FIG. 30 is a diagram showing a different event display screen;

FIG. 31 is a diagram showing the event reservation system according to a 3_3 embodiment;

FIG. 32 is a diagram showing processing in a case where a meal place information distribution request from the user terminal is received in the 3_3 embodiment;

FIG. 33 is a diagram showing the main screen according to the 3_3 embodiment;

FIG. 34 is a diagram showing a meal place display screen;

FIG. 35 is a diagram showing the event information according to a 3_4 embodiment;

FIG. 36 is a diagram showing the main screen according to the 3_4 embodiment;

FIG. 37 is a diagram showing a way-of-enjoying display screen;

FIG. 38 is a diagram showing the event information according to a 3_5 embodiment;

FIG. 39 is a diagram showing the main screen according to the 3_5 embodiment;

FIG. 40 is a diagram showing a recommended imaging point display screen;

FIG. 41 is a diagram showing a state where a reminder is distributed to the user terminal;

FIG. 42 is a diagram showing a home screen of the user terminal on which the reminder is displayed;

FIG. 43 is a diagram showing a state where image upload notification is distributed to the user terminal;

FIG. 44 is a diagram showing a home screen of a user terminal on which an image upload notification is displayed;

FIG. 45 is a diagram showing a state where a free time in a schedule table is selected by a finger; and

FIG. 46 is a diagram showing processing in a case where the free time in the schedule table is selected in a sixth embodiment.

### DETAILED DESCRIPTION

### 1_1 Embodiment

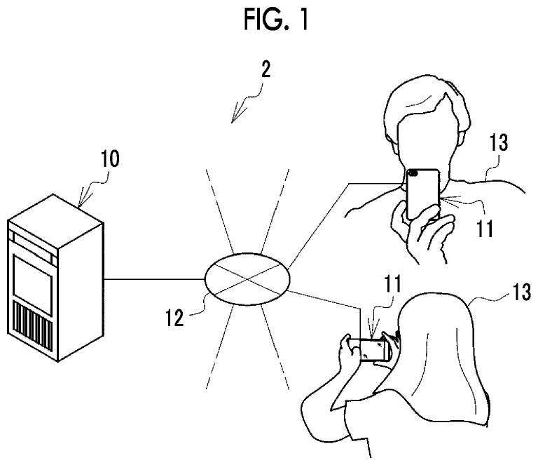

As shown in FIG. 1 as an example, an event reservation system 2 includes an event reservation server 10 and a plurality of user terminals 11. The event reservation server 10 and the user terminal 11 are communicably connected through a network 12. The network 12 is, for example, a wide area network (WAN) such as the Internet and a public communication network.

The event reservation server 10 is, for example, a server computer or a workstation and is an example of an “information presentation device” according to the technique of the present disclosure. The user terminal 11 is a terminal owned by each user 13. The user terminal 11 is, for example, a smartphone, a tablet terminal, a personal computer, and the like.

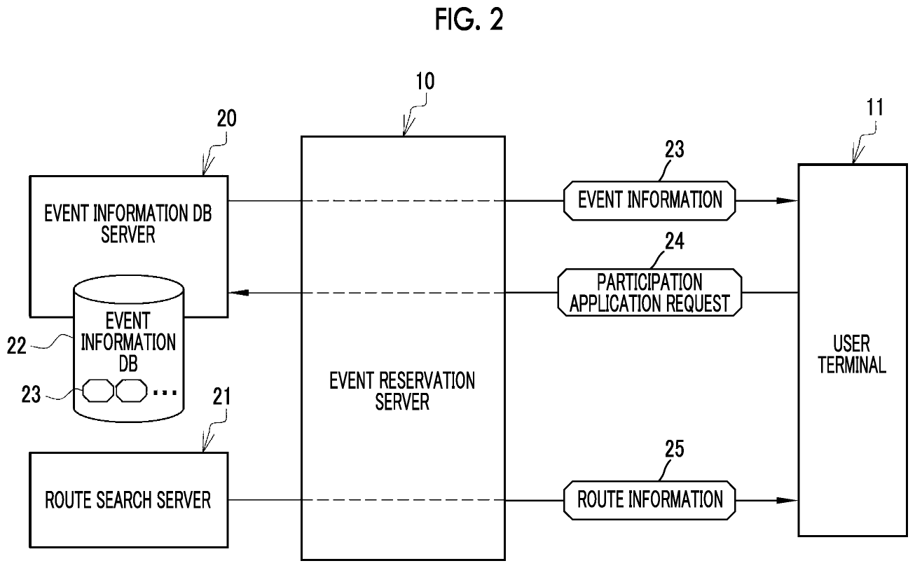

As shown in FIG. 2 as an example, an event information database (hereinafter abbreviated as DB) server 20 and a route search server 21 are connected to the event reservation server 10 through a network (not shown) such as a local area network (LAN). The event information DB server 20 has an event information DB 22. The event information DB 22 stores event information 23.

The event information 23 includes, for example, a tour of sightseeing spots, a tour of playing in a theme park, outdoor experiences (camping, fishing, mountain climbing, kayaking, surfing, and the like), agricultural experiences (rice planting, potato digging, and the like), craft experiences (ceramics, glass crafts, bamboo crafts, and the like), lifelong learning experiences (regional history, gardening, and the like), and a stamp rally. The event information 23 is registered in the event information DB 22 in advance by an event organizer. The organizer is, for example, an employee or staff member of a travel agency, an event planning company, a local public body, or the like.

The event information DB server 20 transmits the event information 23 of the event information DB 22 to the event reservation server 10. The event reservation server 10 distributes the event information 23 to the user terminal 11.

The user 13 browses the event information 23 distributed from the event reservation server 10 through the user terminal 11. The user 13 operates the user terminal 11 to select the event information 23 of the event to be participated in from the event information 23 distributed from the event reservation server 10. The user 13 applies for the participation in the event of the selected event information 23. Accordingly, a participation application request 24 is transmitted from the user terminal 11 to the event reservation server 10.

The user 13 intends, for example, a day trip to a nearby sightseeing trip and applies for the participation in a plurality of events in one day. The user 13 intends an overnight trip to a far place using Saturday and Sunday or the like and applies for the participation in a plurality of events on a plurality of consecutive days. The event reservation server 10 determines whether or not the plurality of events have the same itinerary based on a date and time of participation in each event, a positional relationship of a place of each event, and the like.

The route search server 21 transmits route information 25, which is information related to a route between two application event places having an order that is changed in the same itinerary, to the event reservation server 10. The event reservation server 10 distributes the route information 25 to the user terminal 11. The route information 25 is an example of “first additional information” according to the technique of the present disclosure.

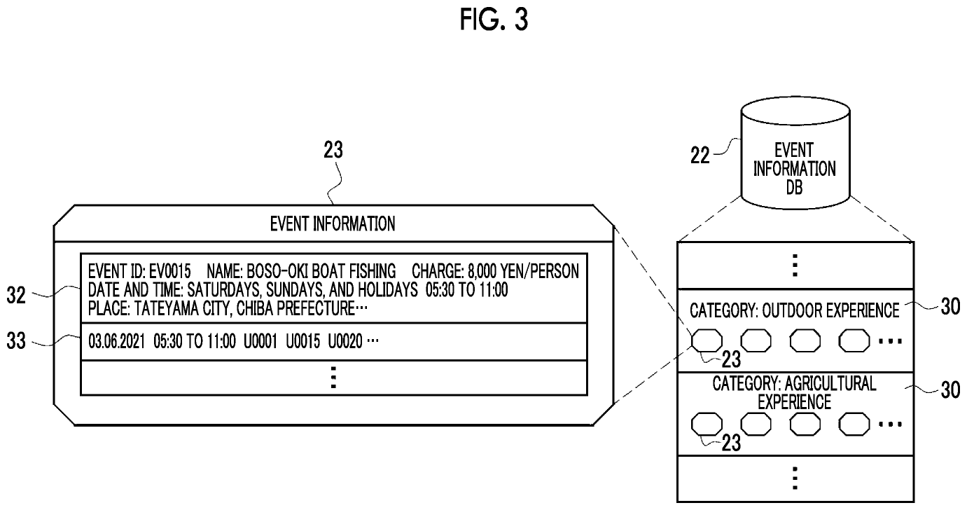

As shown in FIG. 3 as an example, the event information DB 22 is divided into a plurality of categories 30, and each category 30 stores a plurality of pieces of event information 23. The category 30 is a major category of events such as the “outdoor experience” and the “agricultural experience”. In addition to the above events, the category 30 includes the “tour of sightseeing spot”, the “tour of playing in theme park”, the “craft experience”, and the “lifelong learning experience”.

The event information 23 includes basic information 32, application user information 33, and the like. The basic information 32 includes an event identification data (ID) for uniquely identifying the event, a name, a charge, a date and time, a place, and the like. The event ID is automatically assigned by the event information DB server 20 in a case where the event information 23 is first stored in the event information DB 22. In the application user information 33, a user ID of the user 13 who applies for the participation in the event through the user terminal 11, such as “U0001” or “U0015”, is registered for each event participation date and time.

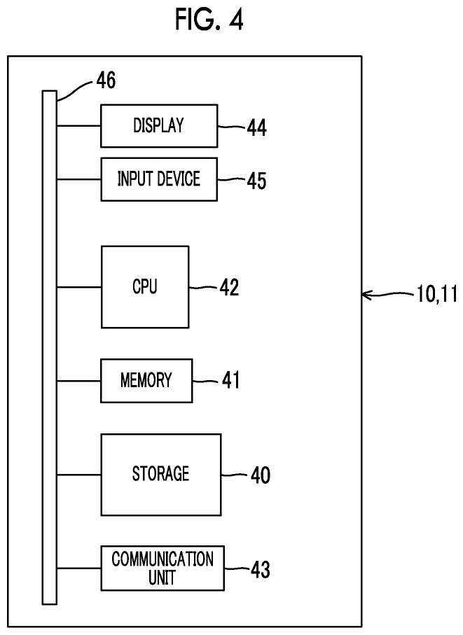

As shown in FIG. 4 as an example, the computers constituting the event reservation server 10 and the user terminal 11 have basically the same configuration and comprises a storage 40, a memory 41, a central processing unit (CPU) 42, a communication unit 43, a display 44, and an input device 45. The above parts are interconnected through a bus line 46.

The storage 40 is a hard disk drive built in the computers constituting the event reservation server 10 and the user terminal 11, or connected through a cable or a network. Alternatively, the storage 40 is a disk array in which a plurality of hard disk drives are continuously mounted. The storage 40 stores a control program such as an operating system, various application programs (hereinafter abbreviated as AP), various pieces of data accompanying these programs, and the like. A solid state drive may be used instead of the hard disk drive.

The memory 41 is a work memory for the CPU 42 to execute processing. The CPU 42 loads the program stored in the storage 40 into the memory 41 to execute the processing according to the program. Accordingly, the CPU 42 integrally controls each part of the computer. The CPU 42 is an example of a “processor” according to the technique of the present disclosure. The memory 41 may be built in the CPU 42.

The communication unit 43 is a network interface that controls transmission of various types of information through the network 12 or the like. The display 44 displays various screens. The various screens are provided with an operation function by a graphical user interface (GUI). The computers constituting the event reservation server 10 and the user terminal 11 receive an input of an operation instruction from the input device 45 through the various screens. The input device 45 is a keyboard, a mouse, a touch panel, and the like.

In the following description, a suffix “A” is assigned to each part of the computer constituting the event reservation server 10, and a suffix “B” is assigned to each part of the computer constituting the user terminal 11 as reference numerals to distinguish the computers.

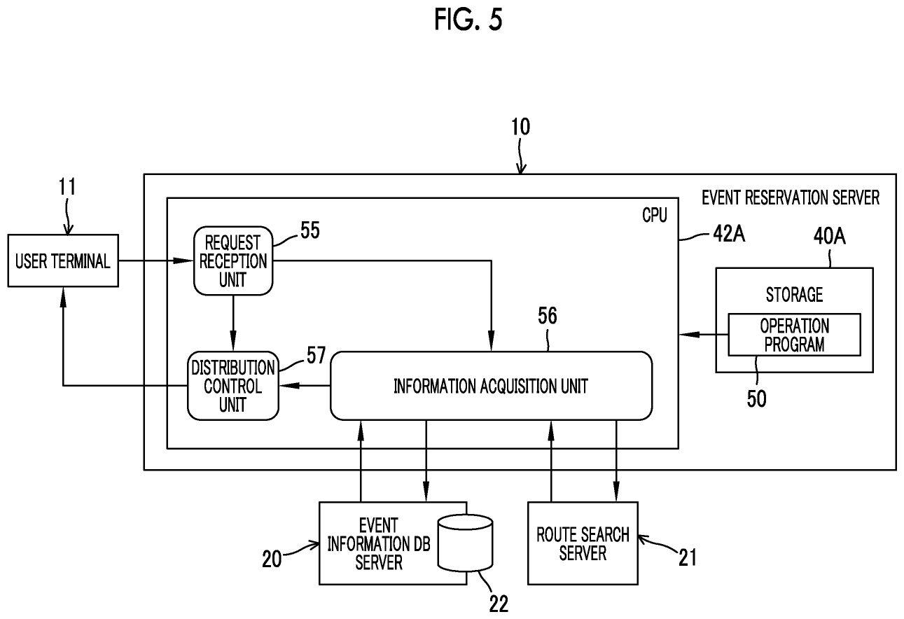

As shown in FIG. 5 as an example, an operation program 50 is stored in a storage 40A of the event reservation server 10. The operation program 50 is an AP for causing the computer constituting the event reservation server 10 to function as an “information presentation device” according to the technique of the present disclosure. That is, the operation program 50 is an example of an “operation program of information presentation device” according to the technique of the present disclosure.

In a case where the operation program 50 is started, a CPU 42A of the event reservation server 10 functions as a request reception unit 55, an information acquisition unit 56, and a distribution control unit 57 in cooperation with the memory 41 and the like.

The request reception unit 55 receives various requests from the user terminal 11. The request reception unit 55 outputs the various requests to the information acquisition unit 56 and the distribution control unit 57.

The information acquisition unit 56 acquires, from the event information DB server 20 or the route search server 21, various types of information according to the various requests from the request reception unit 55. The information acquisition unit 56 outputs the acquired various types of information to the distribution control unit 57.

The distribution control unit 57 performs control of distributing the various types of information from the information acquisition unit 56 to the user terminal 11, which is a transmission source of the various requests.

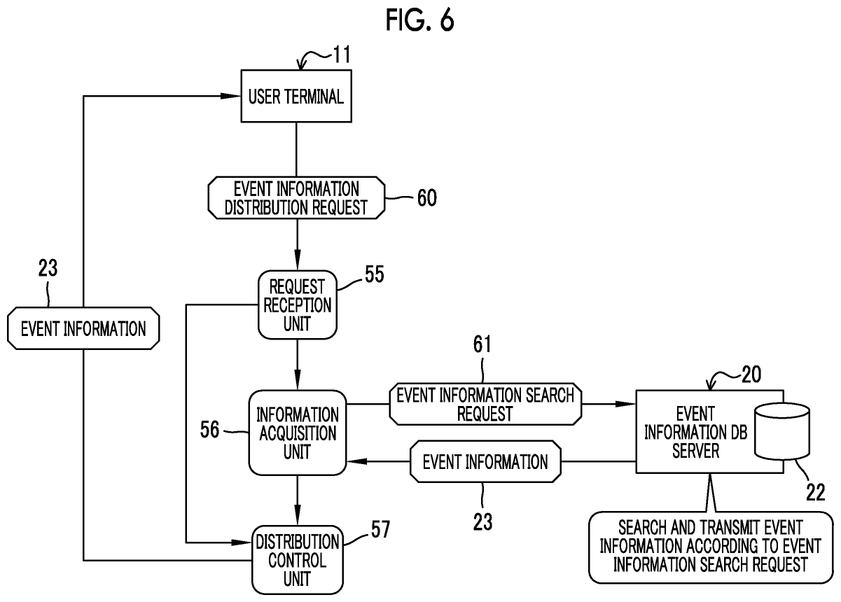

As shown in FIG. 6 as an example, the request reception unit 55 receives an event information distribution request 60 from the user terminal 11. The event information distribution request 60 includes a search keyword for the event desired by the user 13. The search keyword is, for example, at least any one of the category 30, part or all of a name, charge, date and time, or part or all of the place of the event. The event information distribution request 60 includes a terminal ID. The terminal ID is an ID of the user terminal 11 that transmits the event information distribution request 60. The request reception unit 55 outputs the search keyword of the event information distribution request 60 to the information acquisition unit 56. The request reception unit 55 outputs the terminal ID of the event information distribution request 60 to the distribution control unit 57.

The information acquisition unit 56 transmits, to the event information DB server 20, an event information search request 61 that is a copy of the search keyword of the event information distribution request 60. The event information DB server 20 searches for the event information 23 according to the event information search request 61 from the event information DB 22 and transmits the searched event information 23 to the information acquisition unit 56. The information acquisition unit 56 acquires the event information 23 from the event information DB server 20. The information acquisition unit 56 outputs the acquired event information 23 to the distribution control unit 57.

The distribution control unit 57 distributes the event information 23 from the information acquisition unit 56 to the user terminal 11, which is the transmission source of the event information distribution request 60. In this case, the distribution control unit 57 specifies the user terminal 11, which is the transmission source of the event information distribution request 60, based on the terminal ID of the event information distribution request 60 from the request reception unit 55. The distribution control unit 57 distributes the event information 23 to the user terminal 11 in this manner to present the event to the user 13.

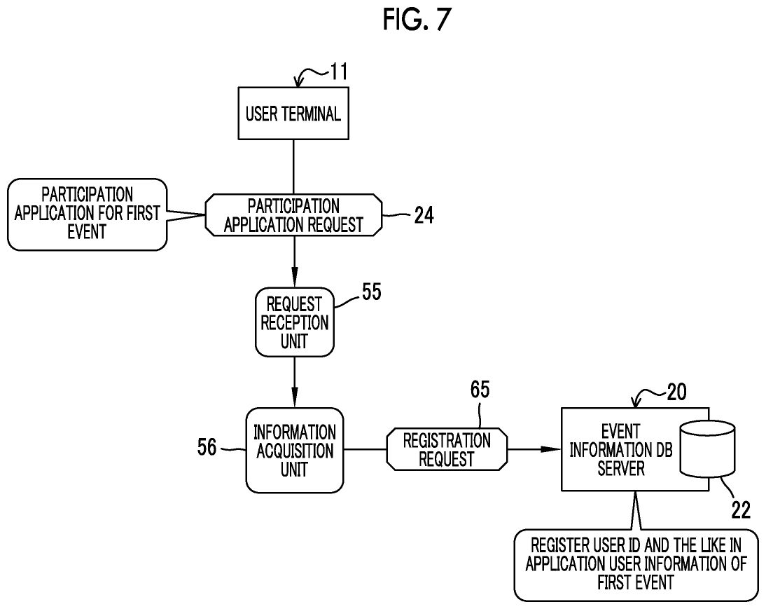

As shown in FIGS. 7, 8, and 9 as an example, the request reception unit 55 receives the participation application request 24 from the user terminal 11. The participation application request 24 includes the event ID, the event participation date and time, the user ID, and the terminal ID. The request reception unit 55 outputs the participation application request 24 to the information acquisition unit 56. The request reception unit 55 receives the participation application request 24 in this manner to receive the participation application for the event by the user 13.

The information acquisition unit 56 transmits, to the event information DB server 20, a registration request 65 that is a copy of the participation application request 24. The event information DB server 20 registers the event participation date and time included in the registration request 65 and the user ID in the application user information 33 of the event information 23 of the event ID included in the registration request 65.

FIG. 7 shows a case where the user 13 applies for participation in a first event that is a first event in the same itinerary. In this case, the information acquisition unit 56 transmits the registration request 65 to the event information DB server 20 to cause the event information DB server 20 to register the user ID and the like in the application user information 33 of the first event, and ends the processing.

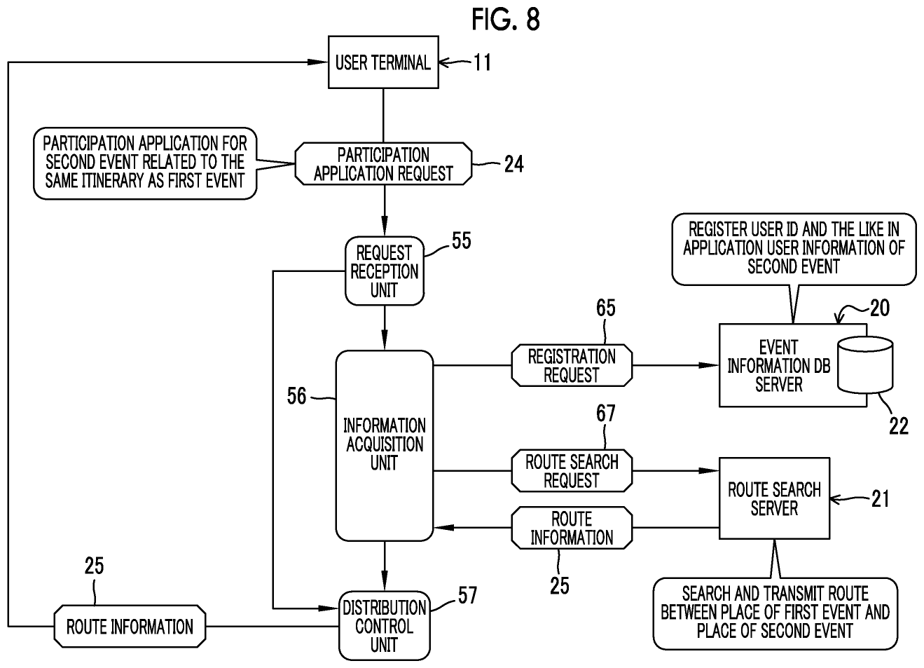

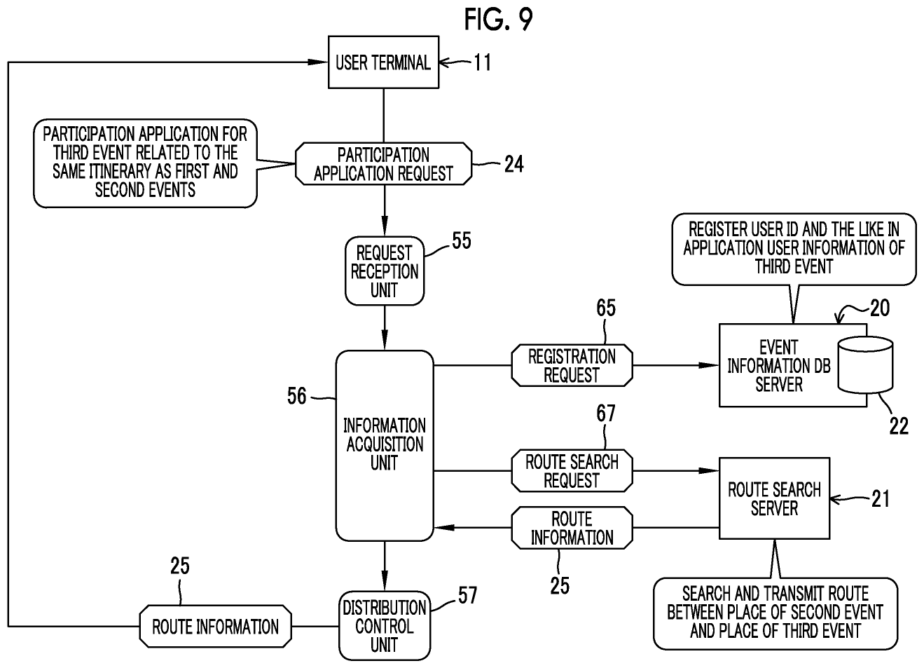

On the other hand, FIG. 8 shows a case where the user 13 applies for participation in a second event related to the same itinerary as the first event. FIG. 9 shows a case where the user 13 applies for participation in a third event related to the same itinerary as the first and second events. In these cases, the information acquisition unit 56 transmits a route search request 67 to the route search server 21.

The route search request 67 in FIG. 8 includes a place of the first event and a place of the second event and is a content that requests the search for the route information 25 between the places of the first and second events. The route search server 21 searches for a route between the places of the first and second events and transmits the search result as the route information 25 to the information acquisition unit 56. The route search request 67 in FIG. 9 includes the place of the second event and a place of the third event and is a content that requests the search for the route information 25 between the places of the second and third events. The route search server 21 searches for a route between the places of the second and third events and transmits the search result as the route information 25 to the information acquisition unit 56.

The information acquisition unit 56 acquires the route information 25 from the route search server 21. The information acquisition unit 56 outputs the acquired route information 25 to the distribution control unit 57. The distribution control unit 57 distributes the route information 25 from the information acquisition unit 56 to the user terminal 11, which is the transmission source of the participation application request 24. In this case, the distribution control unit 57 specifies the user terminal 11, which is the transmission source of the participation application request 24, based on the terminal ID of the participation application request 24 from the request reception unit 55. The distribution control unit 57 distributes the route information 25 to the user terminal 11 in this manner to present the route information 25 to the user 13. The participation application request 24 is an example of “related information” and an “information related to participation application” according to the technique of the present disclosure. The first event in FIG. 8 and the second event in FIG. 9 are examples of the “application event” according to the technique of the present disclosure. The second event in FIG. 8 and the third event in FIG. 9 are examples of a “different event” according to the technique of the present disclosure.

As described above, the event reservation server 10 causes, each time the user 13 makes the event participation application in the same itinerary, the route search server 21 to search for the route information 25 between the two application event places having an order that is changed in the same itinerary. The route information 25 transmitted from the route search server 21 is distributed to the user terminal 11. The two application events having an order that is changed in the same itinerary are determined from the date and time of participation in each event.

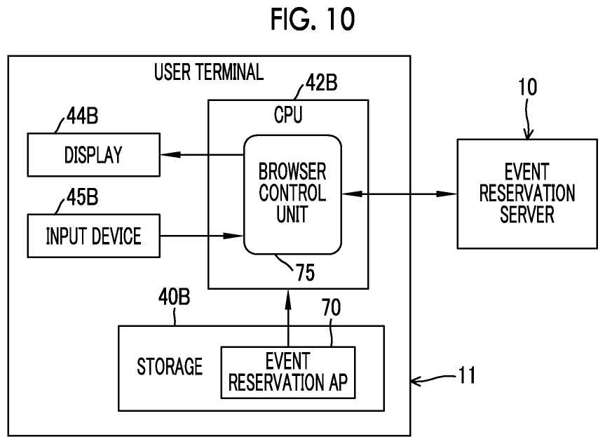

As shown in FIG. 10 as an example, a storage 40B of the user terminal 11 stores an event reservation AP 70. In a case where the event reservation AP 70 is executed and a web browser dedicated to the event reservation AP 70 is started, a CPU 42B of the user terminal 11 functions as a browser control unit 75 in cooperation with the memory 41 and the like. The browser control unit 75 controls the operation of the web browser dedicated to the event reservation AP 70.

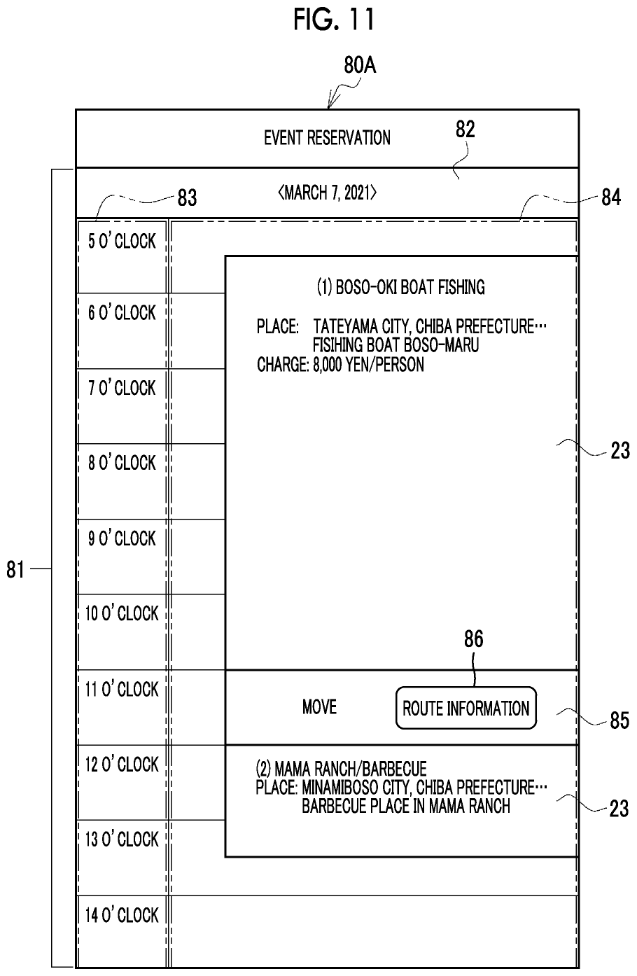

The browser control unit 75 receives various operation instructions to be input from an input device 45B by the user 13 through the various screens. The browser control unit 75 transmits a request in response to the operation instruction to the event reservation server 10. For example, the browser control unit 75 transmits the participation application request 24 to the event reservation server 10 in response to an event participation application instruction. The browser control unit 75 generates various screens such as a main screen 80 (refer to FIG. 11 and the like) and displays the various screens on a display 44B.

As shown in FIG. 11 as an example, a schedule table 81 is displayed on a main screen 80A. The schedule table 81 has a date frame 82, a point-in-time frame 83, and an information frame 84. The date frame 82 displays a date. The date in the date frame 82 can be changed forward and backward. The point-in-time frame 83 displays a point in time for each hour. The information frame 84 displays information indicating a content of a schedule at each point in time on the date of the date frame 82. The information indicating the content of the schedule is, specifically, the event information 23 of the application event and movement information 85 indicating the movement from a place of a previous application event to a place of a next application event. The point-in-time frame 83 and the information frame 84 can be scrolled up and down.

The movement information 85 is displayed in a case where participation in a plurality of events is applied in the same itinerary. In FIG. 11, since the participation in two events of “Boso-oki boat fishing” and “mama ranch/barbecue” is applied, the movement information 85 is displayed between the two events.

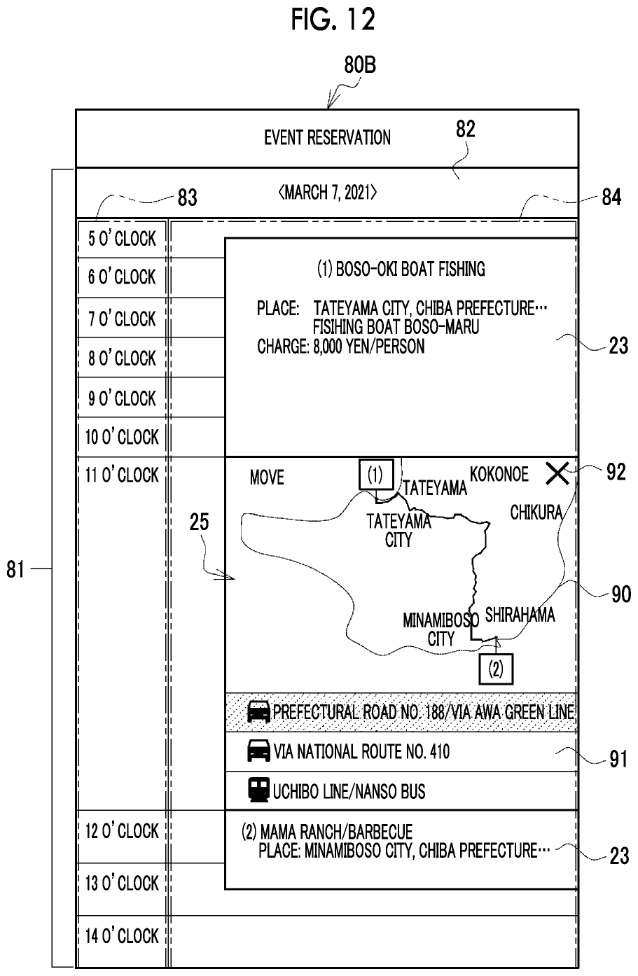

The movement information 85 is provided with a route information display button 86. In a case where the route information display button 86 is selected, a transition to a main screen 80B shown in FIG. 12 is performed as an example. On the main screen 80B, a frame of the movement information 85 is expanded in a vertical direction, and the route information 25 is displayed in the expanded portion. The route information 25 includes a map 90 showing a route connecting the two application event places having an order that is changed in the same itinerary and a candidate 91 for the route. The candidate 91 includes a candidate in a case where an automobile is used as a transportation unit and a candidate in a case where a public transportation such as a train or a bus is used as the transportation unit. The candidate 91 can be alternatively selected. The route of the selected candidate 91 is displayed on the map 90. In a case where a close button 92 is selected, the main screen 80B returns to the main screen 80A.

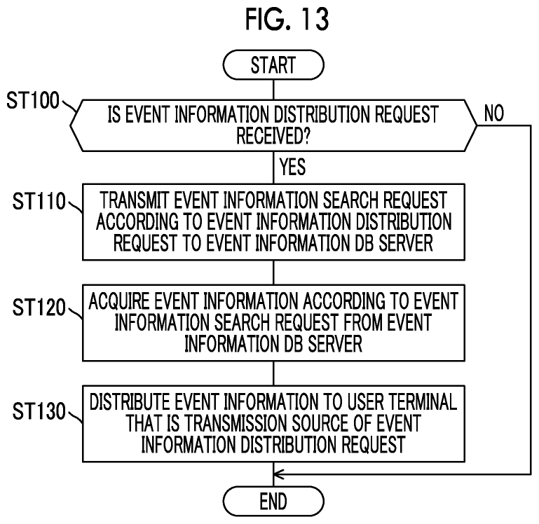

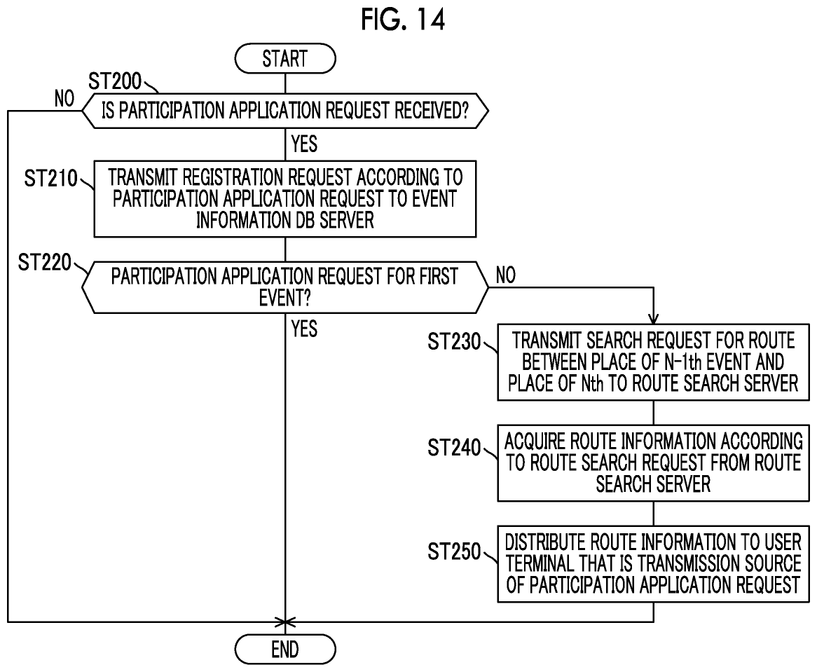

Next, an action of the above configuration will be described with reference to flowcharts shown in FIGS. 13 and 14 as an example. In a case where the operation program 50 is started, the CPU 42A of the event reservation server 10 functions as the request reception unit 55, the information acquisition unit 56, and the distribution control unit 57, as shown in FIG. 5. In a case where the event reservation AP 70 is started, the CPU 42B of the user terminal 11 functions as the browser control unit 75, as shown in FIG. 10.

The user 13 operates the input device 45B to transmit the event information distribution request 60 including the search keyword for the desired event from the browser control unit 75 to the event reservation server 10.

As shown in FIG. 6, in the event reservation server 10, the event information distribution request 60 is received by the request reception unit 55 (YES in step ST100 in FIG. 13). The event information search request 61 according to the event information distribution request 60 is transmitted from the information acquisition unit 56 to the event information DB server 20 (step ST110). In the event information DB server 20, the event information 23 according to the event information search request 61 is searched from the event information DB 22. The event information 23 is transmitted from the event information DB server 20 to the information acquisition unit 56 and is acquired by the information acquisition unit 56 (step ST120). The event information 23 is output from the information acquisition unit 56 to the distribution control unit 57. The event information 23 is distributed to the user terminal 11, which is the transmission source of the event information distribution request 60, under the control of the distribution control unit 57 (step ST130).

The user 13 operates the input device 45B to transmit the participation application request 24 to apply for the participation in the desired event from the browser control unit 75 to the event reservation server 10.

As shown in FIGS. 7 to 9, in the event reservation server 10, the participation application request 24 is received by the request reception unit 55 (YES in step ST200 in FIG. 14). The registration request 65 according to the participation application request 24 is transmitted from the information acquisition unit 56 to the event information DB server 20 (step ST210). In the event information DB server 20, the date and time of participation in the event included in the registration request 65 and the user ID are registered in the application user information 33 of the event information 23 of the event ID included in the registration request 65.

As shown in FIG. 7, in a case where the participation application request 24 received by the request reception unit 55 is the participation application request 24 for the first event, which is the first event in the same itinerary, the processing ends (YES in step ST220). On the contrary, as shown in FIGS. 8 and 9, the participation application request 24 received by the request reception unit 55 is not the participation application request 24 for the first event and the participation application request 24 for a different event in the same itinerary as the first event (NO in step ST220), the route search request 67 is transmitted from the information acquisition unit 56 to the route search server 21 (step ST230). The route search request 67 is a content that requests the search for a route between a place of an N-1th (N is an integer of 2 or more) event and a place of an Nth event.

In the route search server 21, a route according to the route search request 67 is searched for and the route information 25 is generated by the searched route. The route information 25 is transmitted from the route search server 21 to the information acquisition unit 56 and is acquired by the information acquisition unit 56 (step ST240). The route information 25 is output from the information acquisition unit 56 to the distribution control unit 57. The route information 25 is distributed to the user terminal 11, which is the transmission source of the participation application request 24, under the control of the distribution control unit 57 (step ST250).

In the user terminal 11, the main screen 80A on which the schedule table 81 including the event information 23 of the application event is displayed, shown in FIG. 11, is displayed on the display 44B. The user 13 can confirm a content of the application event and the like from the schedule table 81.

In the user terminal 11, the main screen 80B including the route information 25, shown in FIG. 12, is displayed on the display 44B. The route information 25 enables the user 13 to confirm the route between the two application event places having an order that is changed in the same itinerary.

As described above, the CPU 42A of the event reservation server 10 comprises the request reception unit 55, the information acquisition unit 56, and the distribution control unit 57. As shown in FIG. 6, the distribution control unit 57 distributes the event information 23 according to the event information distribution request 60 to the user terminal 11 to present the event to the user 13. As shown in FIGS. 7 to 9, the request reception unit 55 receives the participation application request 24 from the user terminal 11 to receive the participation application for the event by the user 13. As shown in FIGS. 8 and 9, the request reception unit 55 receives the participation application request 24 related to the participation application by the user 13 of the event different from the application event before a start of the application event, as related information related to the application event, which is the event for which the user 13 applies for participation. In this case, the information acquisition unit 56 acquires the route information 25 between the place of the application event and the place of the different event as the first additional information. The distribution control unit 57 distributes the route information 25 to the user terminal 11 to present the route information 25 to the user 13. Therefore, it is possible to present a wide range of useful information to the user 13.

As described above, the related information is the participation application request 24 related to the participation application by the user 13 of the event different from the application event before the start of the application event. The first additional information is the route information 25 between the place of the application event and the place of the different event. The route information 25 is information to be searched almost always in a case where a trip plan is made. In a case where such route information 25 is automatically searched for in response to the participation application request 24 and the searched route information 25 is presented to the user 13, it is possible to save the trouble of the user 13 of searching for the route information 25 using a different AP.

As shown in FIG. 11 and the like, the user 13 is presented with the schedule table 81 including information on the application event. Therefore, the user 13 can grasp the itinerary including the application event at a glance.

On the main screen 80B, it may be possible to perform limited express ticket purchase for train, rental car reservation, taxi arrangement, and the like. Operating entities of the event reservation server 10, the event information DB server 20, and the route search server 21 may be the same or different.

### 1_2 Embodiment

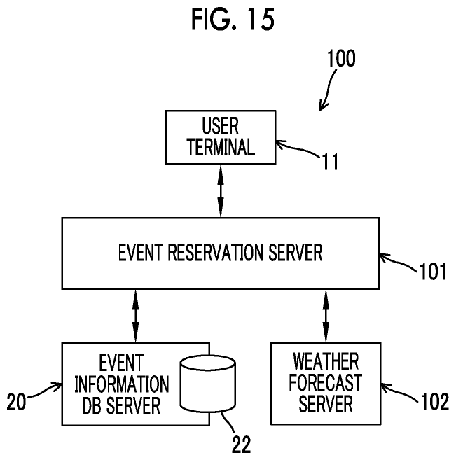

In a 1_2 embodiment shown in FIGS. 15 to 20, a weather forecast for the place of the application event on an event start day is acquired as the related information. The user 13 is presented with information on an alternative event in a case where the weather forecast is unsuitable for the application event, as the first additional information.

As shown in FIG. 15 as an example, a weather forecast server 102 is connected to an event reservation server 101 of the event reservation system 100 of the present embodiment, instead of the route search server 21 according to the 1_1 embodiment.

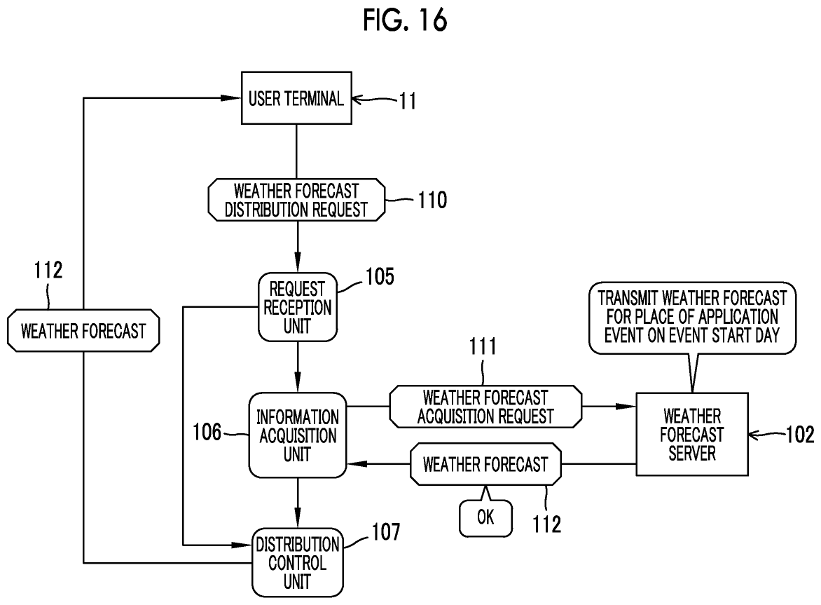

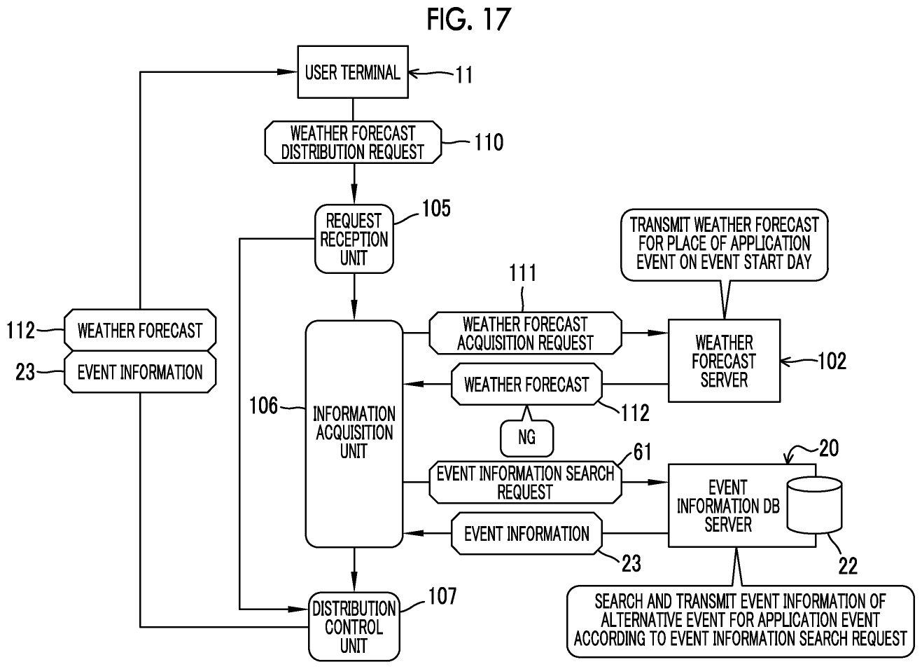

As shown in FIGS. 16 and 17 as an example, a CPU (not shown) of the event reservation server 101 functions as a request reception unit 105, an information acquisition unit 106, and a distribution control unit 107, similarly to the request reception unit 55, the information acquisition unit 56, and the distribution control unit 57 according to the 1_1 embodiment. The request reception unit 105 receives a weather forecast distribution request 110 from the user terminal 11. The weather forecast distribution request 110 includes the participation date and time for the application event, the place, and the terminal ID. The request reception unit 105 outputs the participation date and time and place of the weather forecast distribution request 110 to the information acquisition unit 106. The request reception unit 105 outputs the terminal ID of the weather forecast distribution request 110 to the distribution control unit 107.

The information acquisition unit 106 transmits, to the weather forecast server 102, a weather forecast acquisition request 111 that is a copy of the participation date and time for the application event and place of the weather forecast distribution request 110. The weather forecast server 102 transmits a weather forecast 112 for the place of the application event on the event start day to the information acquisition unit 106 in response to the weather forecast acquisition request 111. The information acquisition unit 106 acquires the weather forecast 112 from the weather forecast server 102. The information acquisition unit 106 outputs the acquired weather forecast 112 to the distribution control unit 107. The weather forecast 112 is an example of the “related information” according to the technique of the present disclosure.

FIG. 16 shows a case where the weather forecast 112 is suitable for the application event (OK). The case where the weather forecast 112 is suitable for the application event is a case of fine weather (sunny) in a case where the application event is an outdoor event. In a case where the application event is an indoor event, the suitable case is a case other than stormy weather (heavy rain, heavy snow, storm, or the like) where it is difficult to reach the place of the application event. In this case, the information acquisition unit 106 transmits the weather forecast acquisition request 111 to the weather forecast server 102, causes the weather forecast server 102 to transmit the weather forecast 112, and ends the processing. The distribution control unit 107 distributes the weather forecast 112 to the user terminal 11, which is the transmission source of the weather forecast distribution request 110.

On the contrary, FIG. 17 shows a case where the weather forecast 112 is unsuitable for the application event (NG). The case where the weather forecast 112 is unsuitable for the application event is a case of bad weather (rain, snow, or the like) in a case where the application event is an outdoor event. In a case where the application event is an indoor event, the unsuitable case is a case of stormy weather where it is difficult to reach the place of the application event. In this case, the information acquisition unit 106 transmits the event information search request 61 to the event information DB server 20. In this case, the event information search request 61 is a content that requests the event information 23 of an alternative event that can be a substitute for the application event. The alternative event includes an indoor event that takes place around the outdoor application event that is inconvenient due to the bad weather, an indoor event that is related to the outdoor application event that is inconvenient due to the bad weather, an indoor event that takes place around a residential area of the user 13, and the like. The residential area of the user 13 is registered in the event reservation server 101 by the user 13 in advance. The event information 23 of the alternative event is an example of the “first additional information” according to the technique of the present disclosure.

The event information DB server 20 searches for, from the event information DB 22, the event information 23 of the alternative event for the application event according to the event information search request 61. The searched event information 23 is transmitted to the information acquisition unit 106. The information acquisition unit 106 acquires the event information 23 of the alternative event from the event information DB server 20. The information acquisition unit 56 outputs the event information 23 of the acquired alternative event to the distribution control unit 57. The distribution control unit 57 distributes the weather forecast 112 and the event information 23 of the alternative event to the user terminal 11, which is the transmission source of the weather forecast distribution request 110.

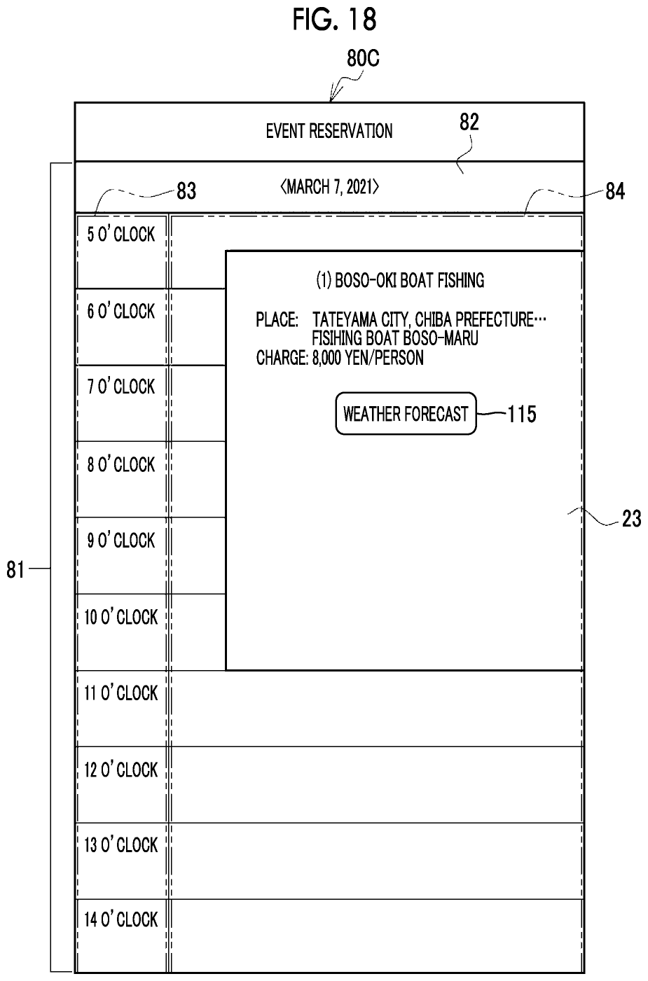

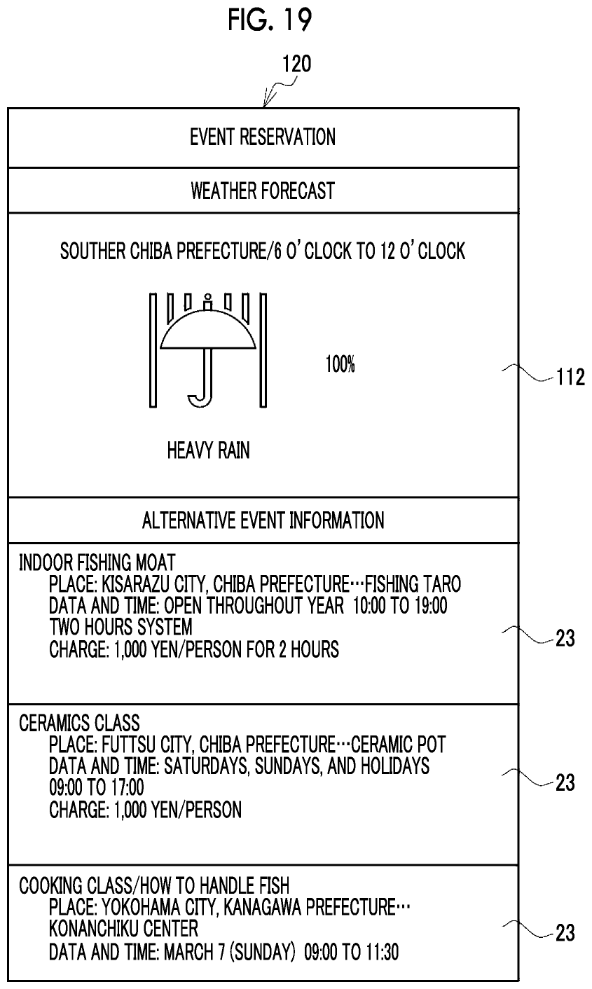

FIG. 18 shows an example of a main screen 80C in the 1_2 embodiment. On the main screen 80C, the event information 23 of the application event displayed in the information frame 84 of the schedule table 81 is provided with a weather forecast display button 115. In a case where the weather forecast display button 115 is selected, the weather forecast distribution request 110 is transmitted from the user terminal 11 to the event reservation server 101. A transition to a weather forecast display screen 120 shown in FIG. 19 is performed as an example.

In FIG. 19, the weather forecast 112 is displayed on the weather forecast display screen 120. In a case where the weather forecast 112 is unsuitable for the application event and the event information 23 of the alternative event is distributed from the event reservation server 101, the event information 23 of the alternative event is displayed on the weather forecast display screen 120. The event information 23 of the alternative event can be scrolled up and down. The event information 23 of the alternative event can be selected. In a case where the event information 23 of the alternative event is selected, a transition to a screen for applying for participation in the alternative event (not shown) is performed and the participation application for the alternative event is possible instead of the application event.

FIG. 18 illustrates a case where the application event is the “Boso-oki boat fishing” in Tateyama City, Chiba Prefecture. FIG. 19 illustrates a case where the weather forecast on the day of the start of “Boso-oki boat fishing” is unsuitable due to “heavy rain”. Further, FIG. 19 illustrates, as the alternative event, an indoor event in Kisarazu City, Chiba Prefecture around Tateyama City, Chiba Prefecture and an “indoor fishing moat” related to the “Boso-oki boat fishing” in terms of fishing, a “ceramics class” which is an indoor event in Kisarazu City, Chiba Prefecture around Tateyama City, Chiba Prefecture, and an indoor event in Yokohama City, Kanagawa Prefecture around the residential area of user 13 and a “cooking class: how to handle fish” related to the “Boso-oki boat fishing” in terms of fish.

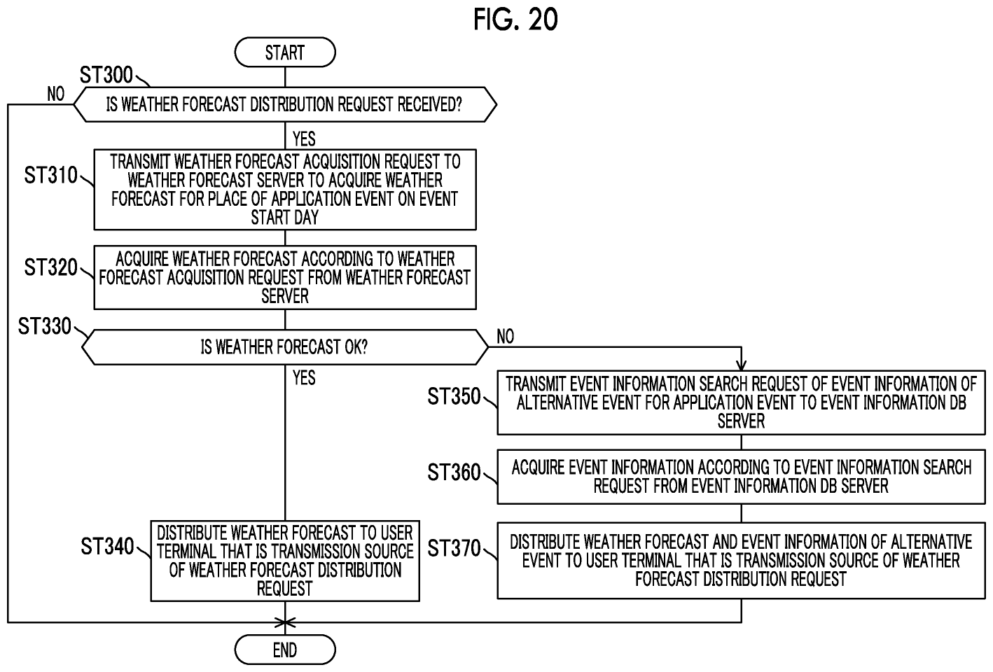

Next, an action of the present embodiment will be described with reference to a flowchart shown in FIG. 20 as an example. In a case where the weather forecast display button 115 of the event information 23 of the application event on the main screen 80C is selected, the weather forecast distribution request 110 is transmitted from the user terminal 11 to the event reservation server 101.

As shown in FIGS. 16 and 17, in the event reservation server 101, the weather forecast distribution request 110 is received by the request reception unit 105 (YES in step ST300). In response to the weather forecast distribution request 110, the weather forecast acquisition request 111 for acquiring the weather forecast 112 for the place of the application event on the event start day is transmitted from the information acquisition unit 106 to the weather forecast server 102 (step ST310). In the weather forecast server 102, the weather forecast 112 according to the weather forecast acquisition request 111 is prepared. The weather forecast 112 is transmitted from the weather forecast server 102 to the information acquisition unit 106 and is acquired by the information acquisition unit 106 (step ST320).

As shown in FIG. 16, in a case where the weather forecast 112 is suitable for the application event (YES in step ST330), the weather forecast 112 is distributed to the user terminal 11, which is the transmission source of the weather forecast distribution request 110, under the control of the distribution control unit 107 (step ST340), and the processing end.

On the contrary, as shown in FIG. 17, in a case where the weather forecast 112 is unsuitable for the application event (NO in step ST330), the event information search request 61 requesting the event information 23 of the alternative event for the application event is transmitted from the information acquisition unit 106 to the event information DB server 20 (step ST350). In the event information DB server 20, the event information 23 of the alternative event according to the event information search request 61 is searched from the event information DB 22. The event information 23 of the alternative event is transmitted from the event information DB server 20 to the information acquisition unit 106 and is acquired by the information acquisition unit 106 (step ST360). The event information 23 of the alternative event is output from the information acquisition unit 56 to the distribution control unit 57. The event information 23 of the alternative event is distributed to the user terminal 11, which is the transmission source of the weather forecast distribution request 110, together with the weather forecast 112 under the control of the distribution control unit 57 (step ST370).

In the user terminal 11, the weather forecast display screen 120 on which the weather forecast 112 and the event information 23 of the alternative event is displayed, shown in FIG. 19, is displayed on the display 44B. The user 13 can confirm the weather forecast 112 and the event information 23 of the alternative event, and in some cases, can also apply for the participation in the alternative event instead of the application event.

As described above, in the 1_2 embodiment, the related information is the weather forecast 112 for the place of the application event on the event start day. The first additional information is the event information 23 of the alternative event in a case where the weather forecast 112 is unsuitable for the application event. Therefore, in a case where the weather forecast 112 is unsuitable for the application event, it is possible to save the trouble of the user 13 of searching for the alternative event. Even though the weather forecast 112 is unsuitable for the application event, the user 13 can revise the trip plan so as to take the trip as scheduled without canceling the trip itself.

The above 1_1 and 1_2 embodiments may be combined and implemented. Specifically, the user 13 is presented with the route information 25 between the place of the application event and the place of the different event in response to the participation application request 24, by the user 13, for the event different from the application event before the start of the application event. Depending on the weather forecast 112 for the place of the application event on the event start day, the user 13 is presented with the event information 23 of the alternative event in a case where the weather forecast 112 is unsuitable for the application event.

The operating entities of the event reservation server 101, the event information DB server 20, and the weather forecast server 102 may be the same or different.

### Second Embodiment

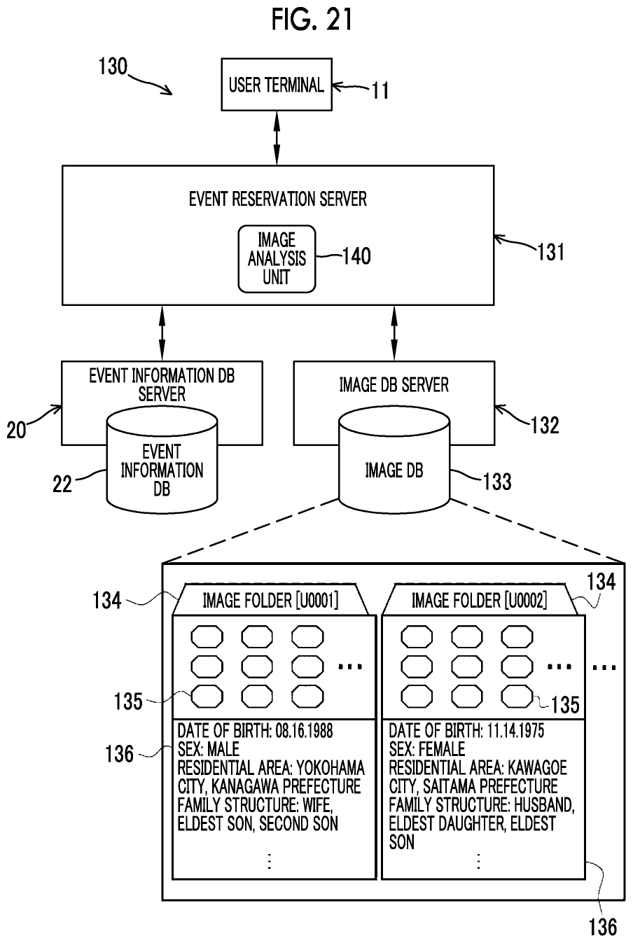

In the above 1_1 embodiment, the event information 23 of the event desired by the user 13 is presented to the user 13, but the present invention is not limited thereto. As in the second embodiment shown in FIGS. 21 to 24, the event information 23 of the event selected based on an image 135 owned by the user 13 may be presented to the user 13.

As shown in FIG. 21 as an example, an image DB server 132 is connected to an event reservation server 131 of an event reservation system 130 according to the present embodiment in addition to the event information DB server 20. Although not shown, the event reservation server 131 is also connected to the route search server 21 and/or the weather forecast server 102.

The image DB server 132 has an image DB 133. The image DB 133 is provided with a plurality of image folders 134. The image folder 134 is a folder addressed to each user 13 one by one and is a folder unique to one user 13. Therefore, the image folders 134 are provided for the number of users 13. The user ID is associated with the image folder 134.

The image 135 owned by the user 13 is stored in the image folder 134. The image 135 owned by the user 13 includes an image captured by the user 13 using a camera function of the user terminal 11. Further, the image 135 owned by the user 13 also includes an image captured by the user 13 using a digital camera other than the user terminal 11. Furthermore, the image 135 owned by the user 13 includes an image received by the user 13 from another user 13 such as a friend or a family member, an image downloaded by the user 13 on an Internet site, an image read by the user 13 with a scanner, and the like. The image 135 in the image folder 134 is periodically synchronized with the image 135 stored locally in the user terminal 11.

Attribute information 136 of the user 13 is associated with the image folder 134. The attribute information 136 is registered by the user 13. The attribute information 136 includes a date of birth, gender, residential area, family structure, and the like of the user 13. The attribute information 136 may be stored in a DB different from the image DB 133.

A CPU (not shown) of the event reservation server 131 functions as an image analysis unit 140, in addition to the request reception unit 55, the information acquisition unit 56, and the distribution control unit 57 according to the 1_1 embodiment, or the request reception unit 105, the information acquisition unit 106, and the distribution control unit 107 according to the 1_2 embodiment. The image analysis unit 140 analyzes a subject reflected in the image 135 stored in the image folder 134 to estimate tastes of the user 13. The image analysis unit 140 outputs the estimation result of the tastes of the user 13 to the information acquisition unit 56 or 106 as an image analysis result.

In the present embodiment, the information acquisition unit 56 or 106 transmits the image analysis result from the image analysis unit 140 and the event information search request 61 with the attribute information 136 as the search keyword to the event information DB server 20. The event information DB server 20 searches for the event information 23 according to the event information search request 61 from the event information DB 22 and transmits the searched event information 23 to the information acquisition unit 56 or 106. Accordingly, the image 135 owned by the user 13 and the event information 23 of the event based on an attribute of the user 13 are selected as recommended event information.

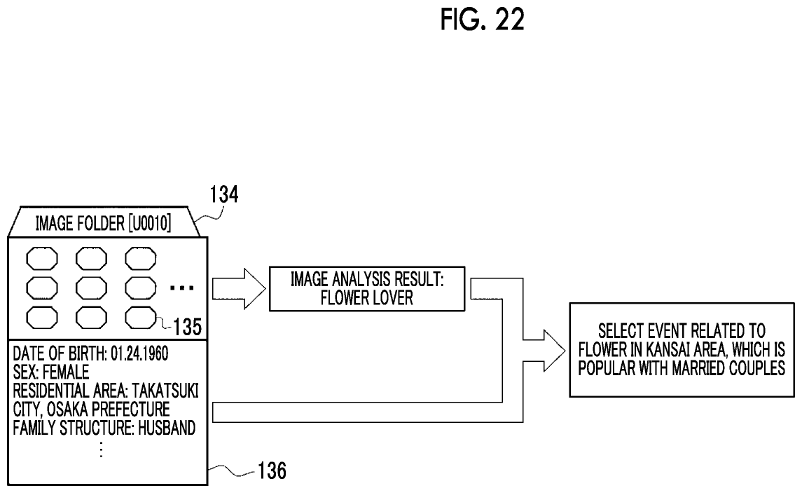

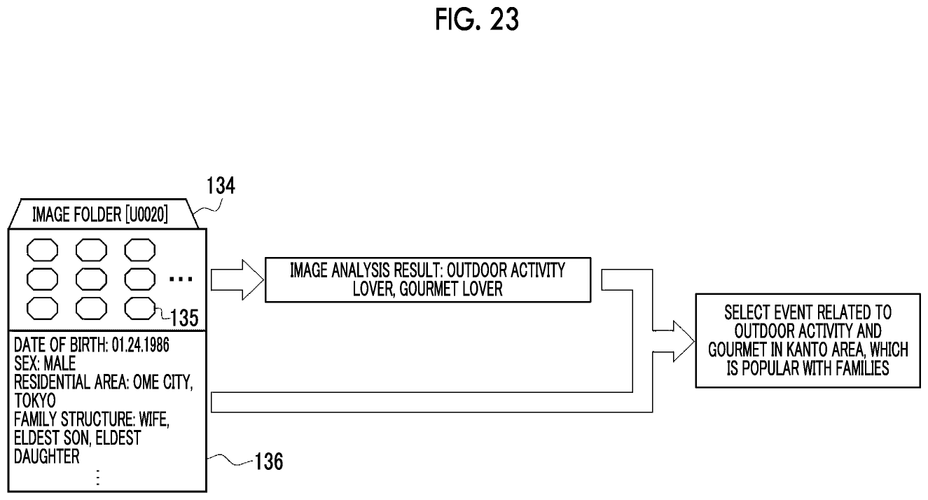

FIGS. 22 and 23 show a state where the event is selected based on the image 135 owned by the user 13 and the attribute of the user 13. FIG. 22 illustrates a case where the image analysis result of the image 135 by the image analysis unit 140 is “flower lover”. Further, FIG. 22 illustrates the user 13 whose residential area is Takatsuki City, Osaka Prefecture and whose family structure has the attribute information 136 of a user's husband. In this case, for example, the event information 23 of the event related to flowers in a Kansai area, which is popular with married couples, is selected as the recommended event information.

FIG. 23 illustrates a case where the image analysis result of the image 135 by the image analysis unit 140 is “outdoor activity lover and gourmet lover”. Further, FIG. 23 illustrates the user 13 whose residential area is Ome City, Tokyo, and whose family structure has the attribute information 136 of a wife, an eldest son, and an eldest daughter. In this case, the event information 23 of events related to the outdoor activity and the gourmet in a Kanto area, which is popular with families, is selected as the recommended event information. The “popular with married couples”, “popular with families”, or the like can be found by collecting attribute statistics of the users 13 who apply for participation in each event.

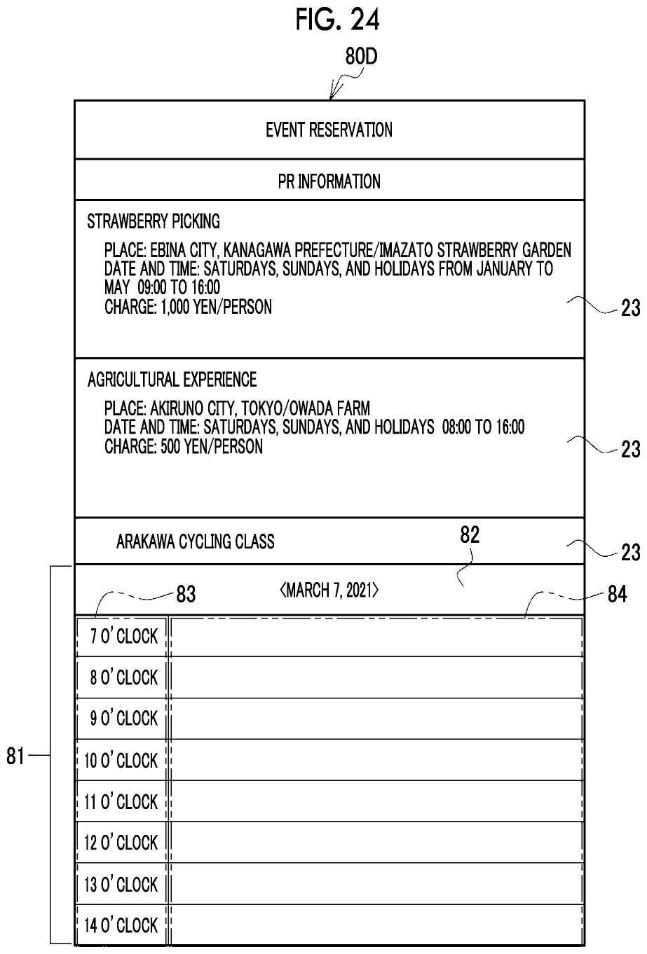

FIG. 24 shows an example of a main screen 80D in the second embodiment. The main screen 80D is displayed, for example, in a case where the event reservation AP 70 is executed and a web browser dedicated to the event reservation AP 70 is started. On the main screen 80D, the recommended event information 23 selected based on the image 135 or the like owned by the user 13 is displayed at an upper part of the schedule table 81. The recommended event information 23 can be scrolled up and down. Further, the recommended event information 23 can be selected. In a case where the recommended event information 23 is selected, a transition to a screen for applying for the participation in the recommended event (not shown) is performed and the participation application for the recommended event is possible.

FIG. 24 shows an example in which the recommended event information 23 for the user 13 shown in FIG. 23 is displayed. That is, as the recommended event information 23, “strawberry picking” in Ebina City, Kanagawa Prefecture and “agricultural experience” in Akiruno City, Tokyo that are events related to the outdoor activity and the gourmet in the Kanto area, which are popular with families.

As described above, in the second embodiment, the event is selected based on the image 135 owned by the user. Therefore, the event information 23 of the event that is likely to be desired by the user 13 can be easily presented to the user 13. A probability that the user 13 applies to participate in the recommended event can be increased as compared with the case where the user 13 is recommended to participate in an event that has nothing to do with the user. In a case where a business model is considered in which revenue is obtained by causing the user 13 to apply for participation in the event, it is possible to contribute to an increase in sales.

The event may be selected based on a history of the application event. For example, the event of category 30 having a relatively high frequency of application is preferentially selected. Alternatively, conversely, the event of the category 30 different from the category 30 having a high frequency of application may be preferentially selected.

The event may be selected based on a browsing time of the event information 23. For example, in a case where the browsing time of the event information 23 of a zoo event is relatively long, the event related to animals is preferentially selected.

The family structure of the user 13 may be estimated from the image 135 held by the user 13. Further, the residential area of the user 13 may be estimated from position information of the user terminal 11 by a global positioning system (GPS) function of the user terminal 11.

The operating entities of the event reservation server 131, the event information DB server 20, and the image DB server 132 may be the same or different.

In 3_1 to 3_5 embodiments described below, second additional information according to the application event is presented to the user 13.

### 3_1 Embodiment

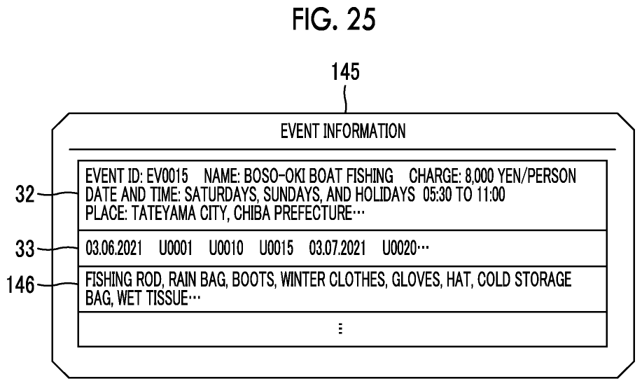

As shown in FIG. 25 as an example, event information 145 according to the present embodiment includes necessary item information 146 in which an item necessary for enjoying the event is registered, in addition to the basic information 32 and the application user information 33. FIG. 25 illustrates the event information 23 of the “Boso-oki boat fishing”. An example is shown in which a fishing rod, a rain bag, boots, winter clothes, gloves, a hat, a cold storage bag, a wet tissue, and the like are registered in the necessary item information 146.

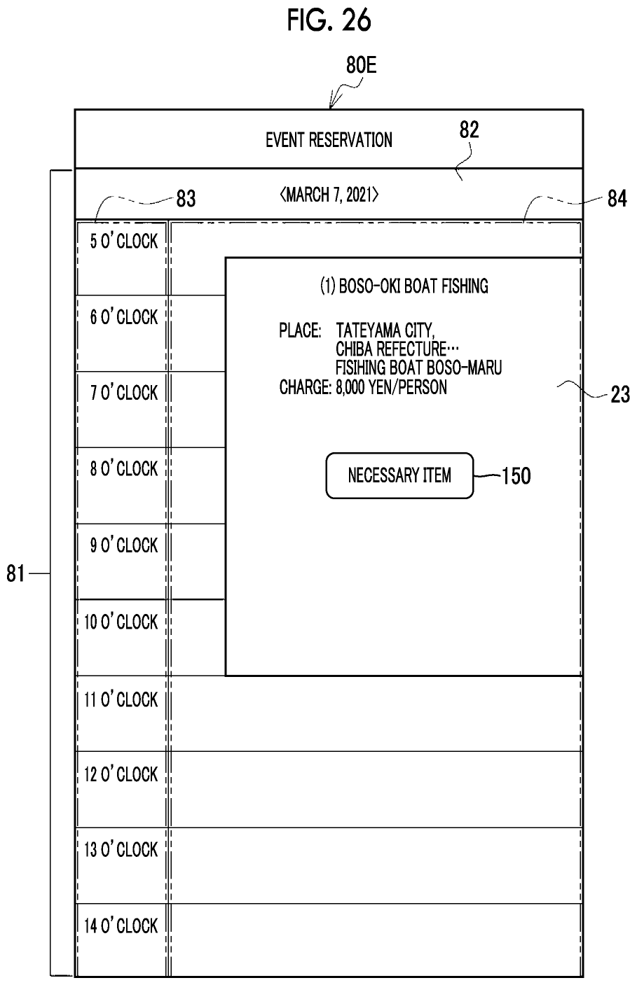

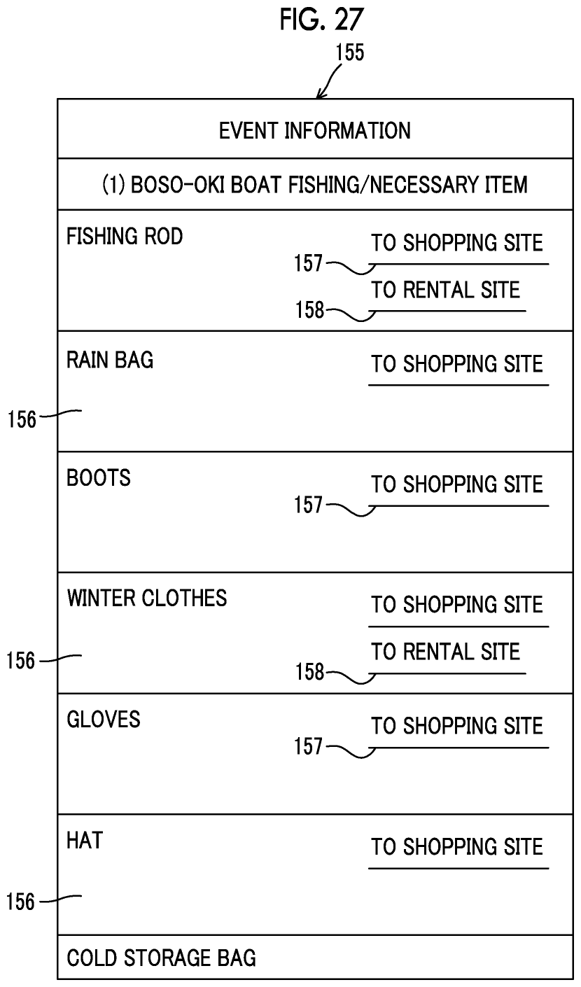

FIG. 26 shows an example of a main screen 80E in the 3_1 embodiment. On the main screen 80E, a necessary item display button 150 is provided in the event information 23 of the application event displayed in the information frame 84 of the schedule table 81. In a case where the necessary item display button 150 is selected, a transition to a necessary item display screen 155 shown in FIG. 27 is performed as an example.

In FIG. 27, display frames 156 for items registered in the necessary item information 146 are displayed on the necessary item display screen 155 in a vertically arranged manner. The display frame 156 can be scrolled up and down. A name of the necessary item, a link 157 to a shopping site of the necessary item, and/or a link 158 to a rental site of the necessary item are displayed in the display frame 156. The link 158 is not displayed in the display frame 156 of the item without the rental site. With the selection of the link 157, a transition to a screen of the shopping site of the item is performed and the item can be purchased. With the selection of the link 158, a transition to a screen of the rental site of the item is performed and the rental of the item can be applied.

As described above, in the 3_1 embodiment, the user 13 is presented with the information on the item necessary for the application event, as the second additional information according to the application event. Therefore, the user 13 can easily grasp the item necessary for the application event. The user 13 may prepare the item necessary for the application event in advance or may think that some item may be rented.

### 3_2 Embodiment

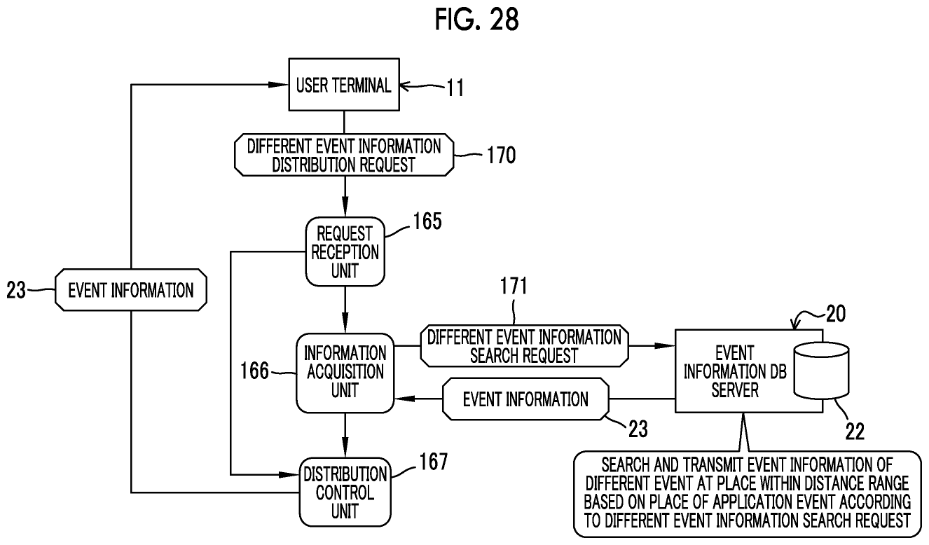

As shown in FIG. 28 as an example, a CPU (not shown) of the event reservation server according to the 3_2 embodiment functions as a request reception unit 165, an information acquisition unit 166, and a distribution control unit 167. The request reception unit 165 receives a different event information distribution request 170 from the user terminal 11. The different event information distribution request 170 requests the distribution of the event information 23 of the different event at a place within a distance range set in advance based on the place of the application event. The “within distance range” is, for example, within a radius of 20 km centered on the place of the application event. The different event information distribution request 170 includes the search keyword for the place within the distance range. Further, the different event information distribution request 170 includes the terminal ID. The request reception unit 165 outputs the search keyword in the different event information distribution request 170 to the information acquisition unit 166. Further, the request reception unit 165 outputs the terminal ID in the different event information distribution request 170 to the distribution control unit 167.

The information acquisition unit 166 transmits, to the event information DB server 20, a different event information search request 171 that is a copy of the search keyword in the different event information distribution request 170. The event information DB server 20 searches for the event information 23 of the different event according to the different event information search request 171 from the event information DB 22 and transmits the searched event information 23 of the different event to the information acquisition unit 166. The information acquisition unit 166 acquires the event information 23 of the different event from the event information DB server 20. The information acquisition unit 166 outputs the acquired event information 23 of the different event to the distribution control unit 167. The distribution control unit 167 distributes the event information 23 of the different event from the information acquisition unit 166 to the user terminal 11, which is the transmission source of the different event information distribution request 170.

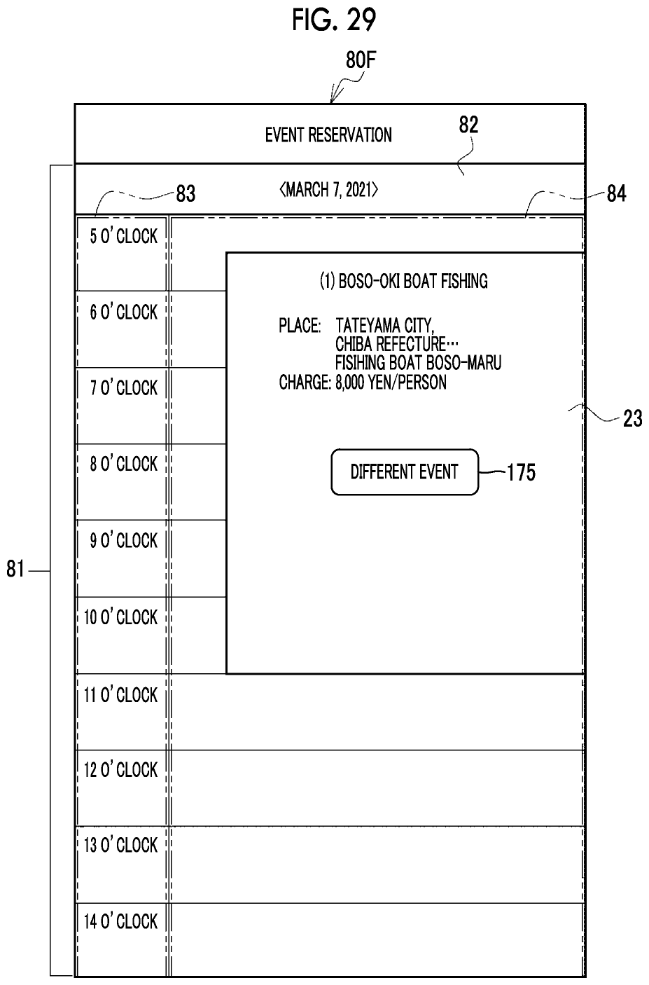

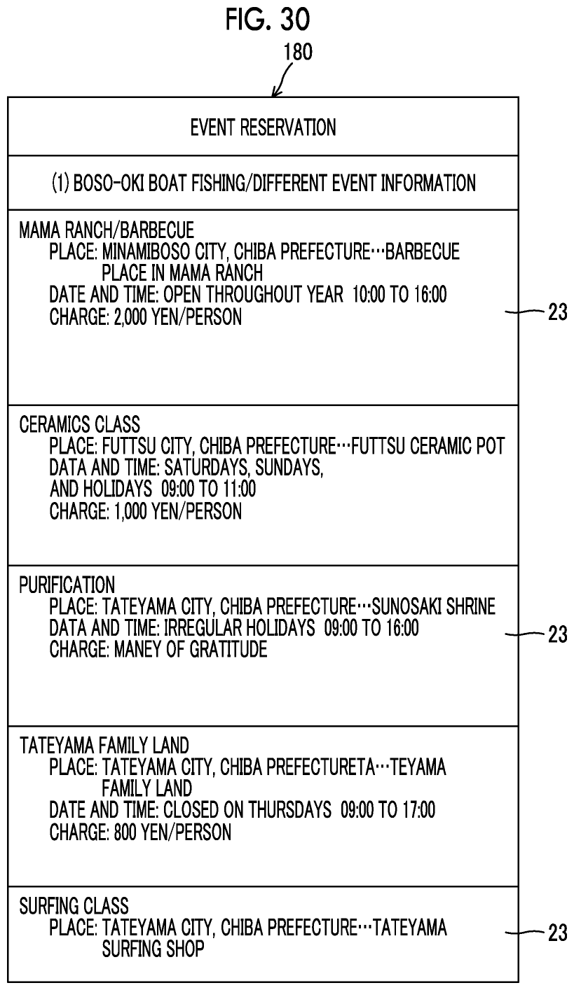

FIG. 29 shows an example of a main screen 80F in the 3_2 embodiment. On the main screen 80F, a different event display button 175 is provided in the event information 23 of the application event displayed in the information frame 84 of the schedule table 81. In a case where the different event display button 175 is selected, the different event information distribution request 170 is transmitted from the user terminal 11 to the event reservation server. A transition to a different event display screen 180 shown in FIG. 30 is performed as an example.

In FIG. 30, the event information 23 of the different event distributed from the event reservation server is displayed on the different event display screen 180 in a vertically arranged manner. The event information 23 of the different event can be scrolled up and down. Further, the event information 23 of the different event can be selected. In a case where the event information 23 of the different event is selected, a transition to a screen for applying for participation in the different event (not shown) is performed and the participation application for the different event is possible.

FIG. 29 illustrates the “Boso-oki boat fishing” as the application event. FIG. 30 illustrates, as the different event of “Boso-oki boat fishing”, “mama ranch/barbecue” in Minami-Boso City, Chiba Prefecture, which is within the distance range based on Tateyama City, Chiba Prefecture which is the place of “Boso-oki boat fishing”, “ceramics class” in Futtsu City, Chiba Prefecture, “purification” in Tateyama City, Chiba Prefecture, and the like.

As described above, in the 3_2 embodiment, the user 13 is presented with the event information 23 of the different event in the place within the distance range set in advance based on the place of the application event, as the second additional information according to the application event. Therefore, the user 13 can know the different event that the user can further apply for participation around the place of the application event without any trouble.

### 3_3 Embodiment

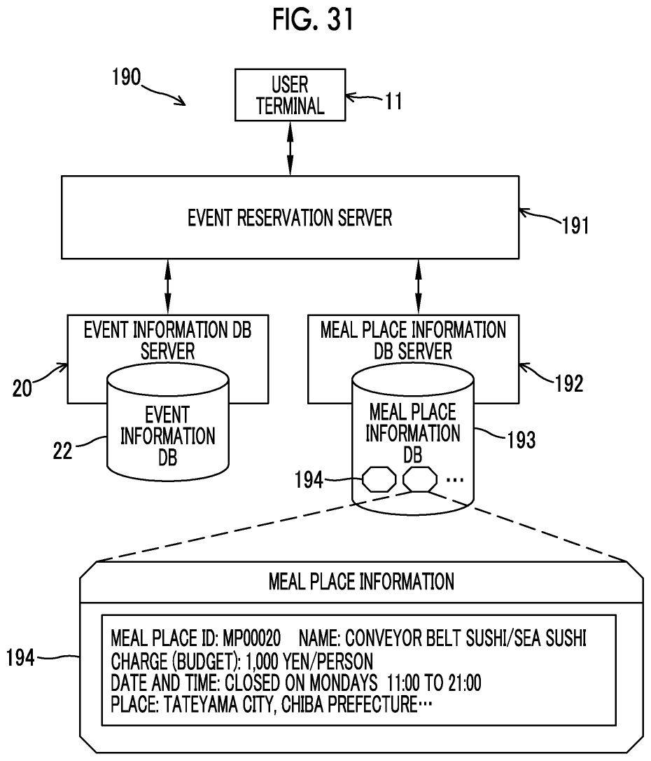

As shown in FIG. 31 as an example, a meal place information DB server 192 is connected to an event reservation server 191 of an event reservation system 190 according to the present embodiment, in addition to the event information DB server 20. Although not shown, the event reservation server 191 is also connected to the route search server 21 and/or the weather forecast server 102.

The meal place information DB server 192 has meal place information DB 193. The meal place information DB 193 stores meal place information 194 of a plurality of meal places. The meal place information 194 includes a meal place ID for uniquely identifying the meal place, a name, a charge (budget), a date and time, a place, and the like. The date and time is a regular holiday and opening hours.

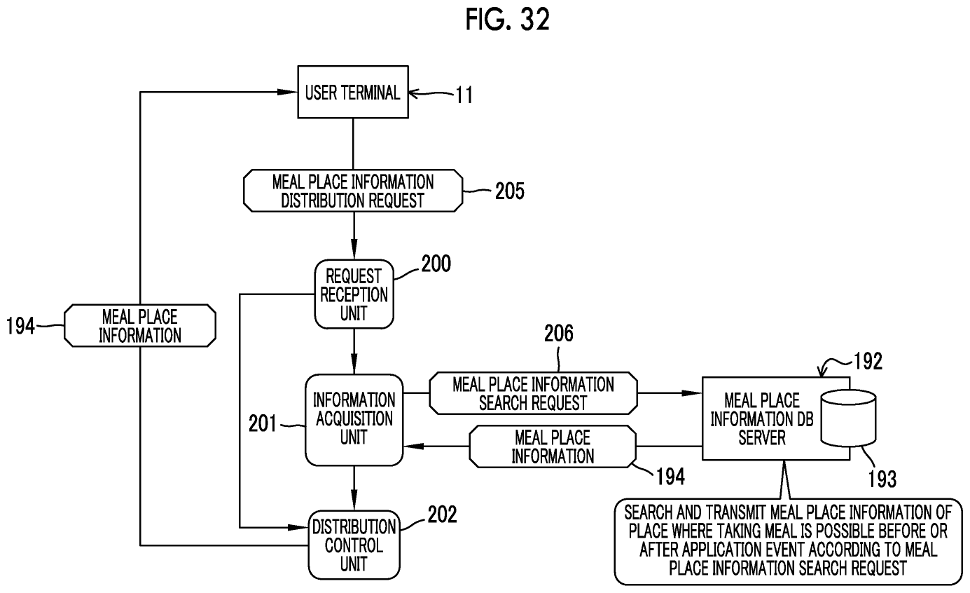

As shown in FIG. 32 as an example, the CPU (not shown) of the event reservation server 191 functions as a request reception unit 200, an information acquisition unit 201, and a distribution control unit 202. The request reception unit 200 receives a meal place information distribution request 205 from the user terminal 11. The meal place information distribution request 205 requests the distribution of the meal place information 194 of the meal place where taking a meal is possible before or after the application event. The meal place information distribution request 205 includes the search keyword for the place around the place of the application event. Further, the meal place information distribution request 205 includes the terminal ID. The request reception unit 200 outputs the search keyword in the meal place information distribution request 205 to the information acquisition unit 201. Further, the request reception unit 200 outputs the terminal ID in the meal place information distribution request 205 to the distribution control unit 202.

The information acquisition unit 201 transmits, to the meal place information DB server 192, the meal place information search request 206 that is a copy of the search keyword of the meal place information distribution request 205. The meal place information DB server 192 searches for the meal place information 194 according to the meal place information distribution request 205 from the meal place information DB 193 and transmits the searched meal place information 194 to the information acquisition unit 201. The information acquisition unit 201 acquires the meal place information 194 from the meal place information DB server 192. The information acquisition unit 201 outputs the acquired meal place information 194 to the distribution control unit 202. The distribution control unit 202 distributes the meal place information 194 from the information acquisition unit 201 to the user terminal 11, which is the transmission source of the meal place information distribution request 205.

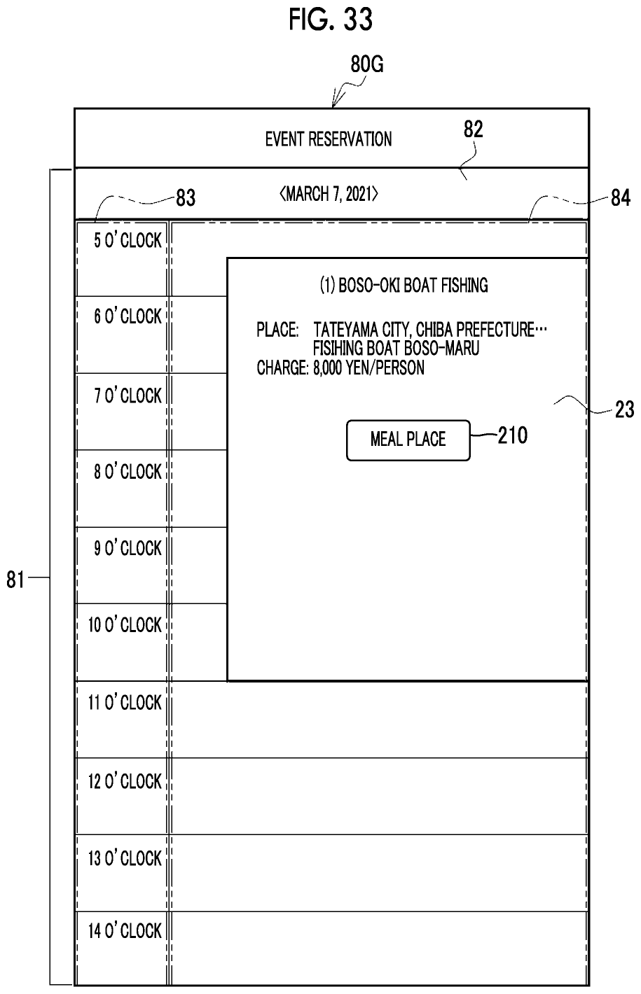

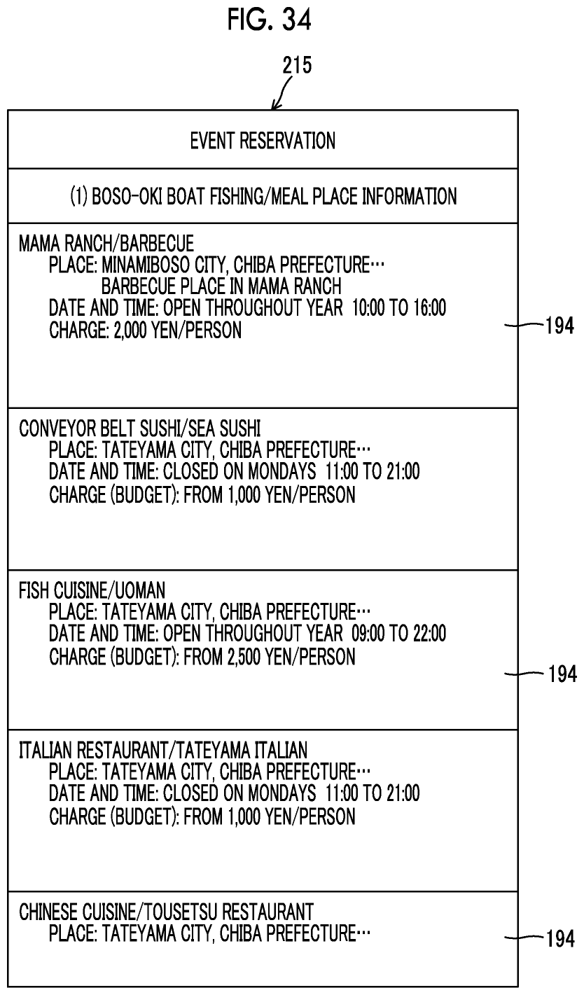

FIG. 33 shows an example of a main screen 80G in the 3_3 embodiment. On the main screen 80G, a meal place display button 210 is provided in the event information 23 of the application event displayed in the information frame 84 of the schedule table 81. In a case where the meal place display button 210 is selected, the meal place information distribution request 205 is transmitted from the user terminal 11 to the event reservation server 191. A transition to a meal place display screen 215 shown in FIG. 34 is performed as an example.

In FIG. 34, the meal place information 194 distributed from the event reservation server 191 is displayed on the meal place display screen 215 in a vertically arranged manner. The meal place information 194 can be scrolled up and down. Further, the meal place information 194 can be selected. In a case where the meal place information 194 is selected, a transition to a screen for reserving a seat at the meal place (not shown) is displayed and the seat at the meal place can be reserved.

FIG. 33 illustrates the “Boso-oki boat fishing” as the application event. FIG. 34 illustrates, as the meal place where taking a meal is possible after “Boso-oki boat fishing”, “mama ranch/barbecue” in Minami-Boso City, Chiba Prefecture, which is around Tateyama City, Chiba Prefecture for “Boso-oki boat fishing”, “conveyor belt sushi/Sea sushi” in Tateyama City, Chiba Prefecture, and “fish cuisine/Unman” in Tateyama City, Chiba Prefecture, and the like.

As described above, in the 3_3 embodiment, the user 13 is presented with the meal place information 194 of the meal place where taking a meal is possible before or after the application event, as the second additional information according to the application event. Therefore, the user 13 can know the meal place where taking a meal is possible before or after the application event without any trouble.

On the meal place display screen 215, the meal place information 194 may be displayed by genre such as Japanese food, Western food, and Chinese food, or by budget. The operating entities of the event reservation server 191, the event information DB server 20, and the meal place information DB server 192 may be the same or different.

### 3_4 Embodiment

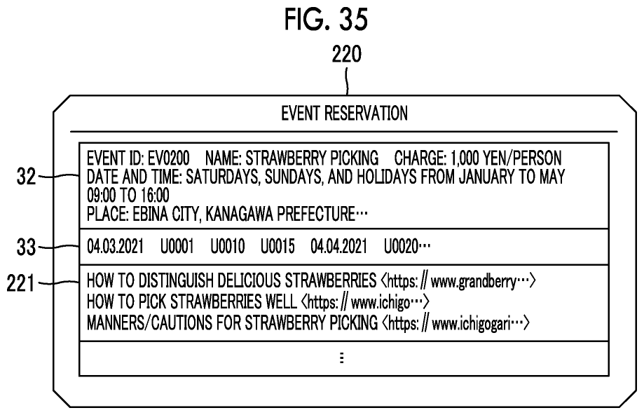

As shown in FIG. 35 as an example, event information 220 of the present embodiment includes way-of-enjoying information 221 in which a website describing a way of enjoying the event is registered, in addition to the basic information 32 and the application user information 33. FIG. 35 illustrates the event information 220 of “strawberry picking”. The way-of-enjoying information 221 shows an example in which a website describing “how to distinguish delicious strawberries”, “how to pick strawberries well”, “manners/cautions for strawberry picking”, or the like is registered.

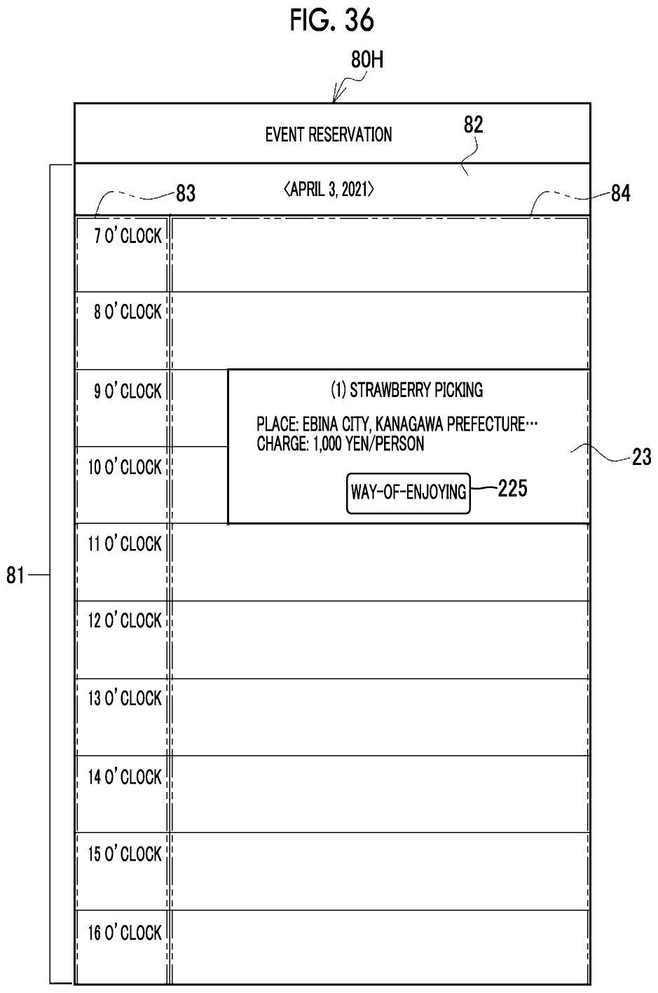

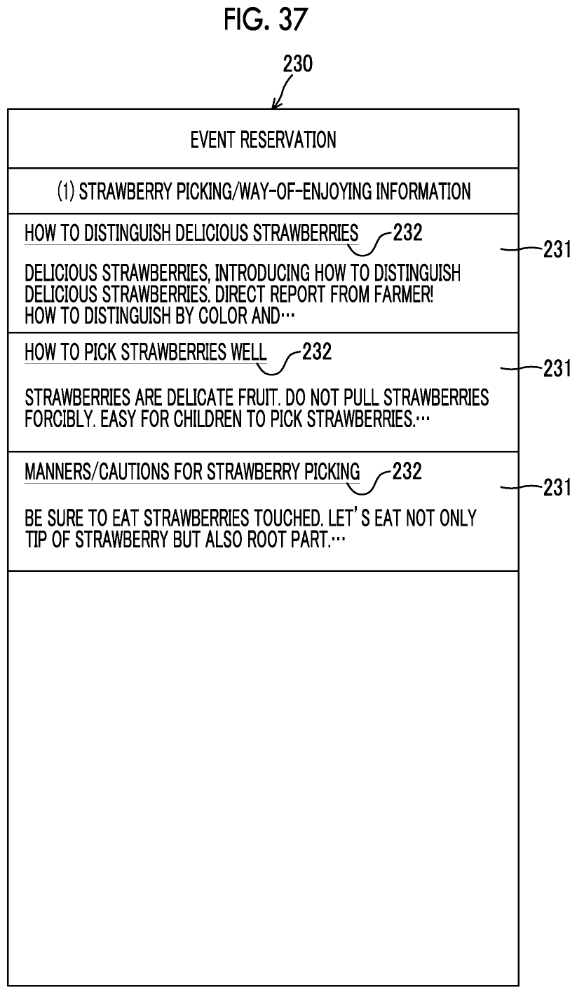

FIG. 36 shows an example of a main screen 80H in the 3_4 embodiment. On the main screen 80H, a way-of-enjoying display button 225 is provided in the event information 23 of the application event displayed in the information frame 84 of the schedule table 81. In a case where the way-of-enjoying display button 225 is selected, a transition to a way-of-enjoying display screen 230 shown in FIG. 37 is performed as an example.

In FIG. 37, display frames 231 for websites registered in the way-of-enjoying information 221 are displayed on the way-of-enjoying display screen 230 in a vertically arranged manner. The display frame 231 displays a title of the website and an excerpt of a text described on the website. The title of the website has a link 232 to the website. With the selection of the link 232, a transition to a screen of the website is performed and the way of enjoying the application event described on the website can be browsed.

FIG. 36 illustrates the “strawberry picking” as the application event. FIG. 37 illustrates, as the way-of-enjoying information 221 of “strawberry picking”, information on the websites describing “how to distinguish delicious strawberries”, “how to pick strawberries well”, “manners/cautions for strawberry picking”.

As described above, in the 3_4 embodiment, the user 13 is presented with the way-of-enjoying information 221 of the application event, as the second additional information according to the application event. Therefore, the user 13 can easily touch the way of enjoying the application event and can enjoy the application event more.

The way-of-enjoying information 221 registered in the event information 220 is presented to the user 13, but the present invention is not limited thereto. The website describing the way of enjoying the event may be searched with the category 30, name, or the like of the application event as the search keyword, and the information on the searched website may be presented to the user 13 as the way-of-enjoying information.

### 3_5 Embodiment

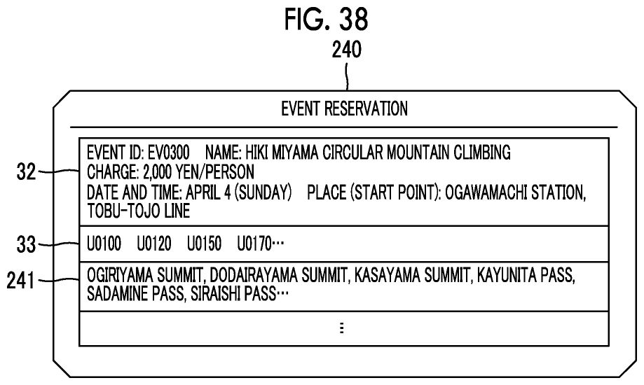

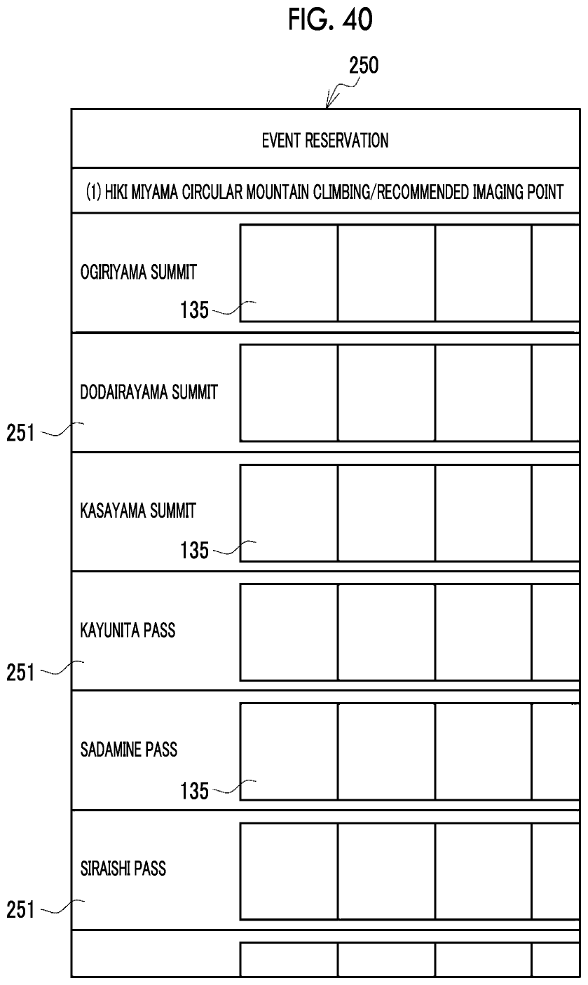

As shown in FIG. 38 as an example, event information 240 of the present embodiment includes recommended imaging point information 241 in which a recommended imaging point in the event is registered, in addition to the basic information 32 and the application user information 33. FIG. 38 illustrates the event information 23 of “Hiki Miyama circular mountain climbing”. An example is shown in which “Ogiriyama summit”, “Dodairayama summit”, “Kayunita pass”, and the like are registered in the recommended imaging point information 241. Although not shown, the recommended imaging point information 241 also stores the image 135 (refer to FIG. 40) that is imaged by an unspecified number of users 13 at each recommended imaging point and is registered in the event reservation server.

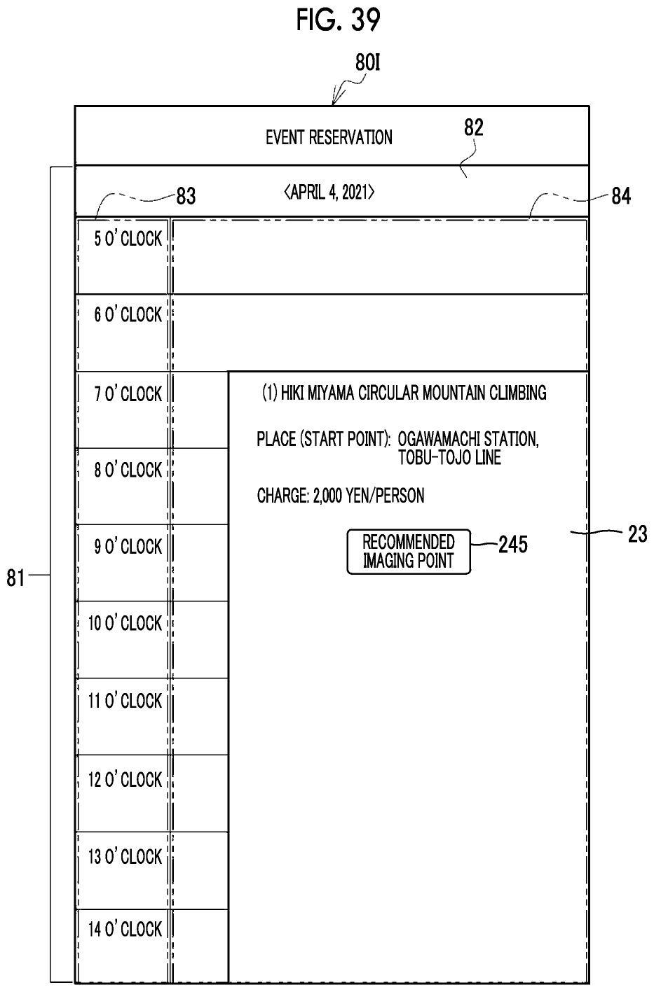

FIG. 39 shows an example of a main screen 801 in the 3_5 embodiment. On the main screen 801, a recommended imaging point display button 245 is provided in the event information 23 of the application event displayed in the information frame 84 of the schedule table 81. In a case where the recommended imaging point display button 245 is selected, a transition to a recommended imaging point display screen 250 shown in FIG. 40 is performed as an example.

In FIG. 40, display frames 251 for recommended imaging points registered in the recommended imaging point information 241 are displayed on the recommended imaging point display screen 250 in a vertically arranged manner. The display frame 251 can be scrolled up and down. The display frame 251 displays a name of the recommended imaging point and a plurality of images 135 imaged at the recommended imaging point. The image 135 can be scrolled left and right. In addition, the image 135 can be selected. In a case where the image 135 is selected, the enlarged image 135 is displayed.

FIG. 39 illustrates the “Hiki Miyama circular mountain climbing” as the application event. FIG. 40 illustrates, as the recommended imaging points of the “Hiki Miyama circular mountain climbing”, “Ogiriyama summit”, “Dodairayama summit”, “Kayunita pass”, and the like.

As described above, in the 3_5 embodiment, the user 13 is presented with information on the recommended imaging point in the application event, as the second additional information according to the application event. Therefore, the user 13 can easily grasp where the recommended imaging point in the application event is and can increase the motivation to image the image 135 at the recommended imaging point. Further, it is possible to prevent the user 13 from forgetting to image at the recommended imaging point and regretting it.

### Fourth Embodiment

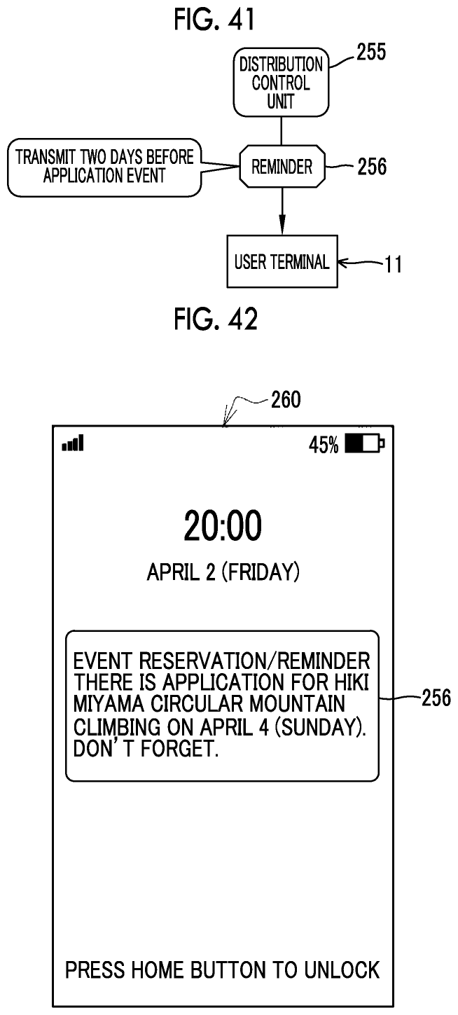

As shown in FIG. 41 as an example, a distribution control unit 255 according to the present embodiment distributes a reminder 256 of the application event to the user terminal 11 two days before the application event, for example, to present the reminder 256 to the user 13. The user terminal 11 that receives the reminder 256 displays the reminder 256 on a home screen 260, as shown in FIG. 42 as an example.

As described above, in the fourth embodiment, the user 13 is presented with the reminder 256 of the application event. Therefore, it is possible to prevent the user 13 from forgetting the application event. The reminder 256 may be presented a plurality of times, such as one week before, three days before, two days before, and one day before the application event. A configuration may be employed in which the user 13 can set a timing of presenting the reminder 256.

The user 13 may be presented with, together with the reminder 256, at least one of the route information 25, the weather forecast 112 and the event information 23 on the alternative event, the recommended event information 23, the information on the item necessary for the application event, the event information 23 on the different event at the place within the distance range based on the place of the application event, the meal place information 194, the way-of-enjoying information 221, or the recommended imaging point information 241. The presented information may be changed depending on the presentation timing of the reminder 256 such as, one week before the application event, the weather forecast 112, the event information 23 on the alternative event, and the information on the item necessary for the application event and, two days before the application event, the way-of-enjoying information 221 and the recommended imaging point information 241.

A configuration may be employed in which the user 13 can select the information presented together with the reminder 256. For example, the reminder 256 is presented together with all of the above information in a case where the reminder 256 is presented first, and the user 13 selects whether or not the presentation is necessary thereafter for each piece of information. In a case where the presentation is not necessary, the information selected by the user 13 is not presented thereafter.

Further, the user 13 may be presented with, together with the reminder 256, the home of the user 13 and the place of the application event, and a recommended departure time calculated back from a point in time of the application event start. The user 13 may be presented with, together with the reminder 256, a list summarizing the items necessary for the application event on a day before the application event or the like.

### Fifth Embodiment

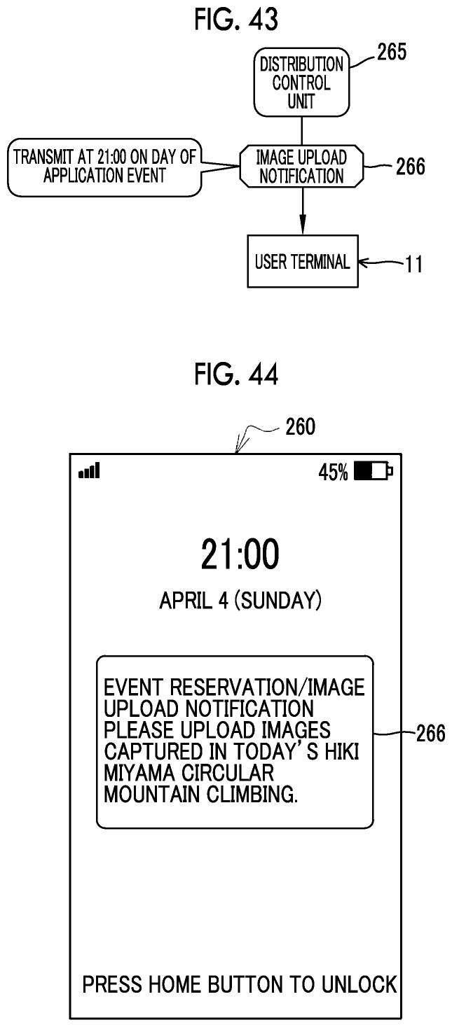

As shown in FIG. 43 as an example, a distribution control unit 265 according to the present embodiment distributes image upload notification 266 to the user terminal 11 at 21:00 on a day of the application event to present the image upload notification 266 to the user 13. The image upload notification 266 is notification to urge the user 13 to upload the image 135 captured by the user 13 in the application event to the image DB server 132. The user terminal 11 that receives the image upload notification 266 displays the image upload notification 266 on the home screen 260, as shown in FIG. 44 as an example.

As described above, in the fifth embodiment, the application event is executed and then the user 13 is presented with the image upload notification 266 to urge the user 13 to upload the image 135 captured in the application event. Therefore, it is possible to prevent the user 13 from forgetting to upload the image 135 captured in the application event.

In a case where it is detected that the user terminal 11 is connected to home Wi-Fi (registered trademark) of the user 13, the image upload notification 266 may be presented. Alternatively, in a case where the GPS function of the user terminal 11 detects that the user 13 returns home, the image upload notification 266 may be presented.

In a case where the upload of the image 135 captured in the application event completes, the image DB server 132 may automatically create an electronic album using the image 135 captured in the application event. A best shot image 135 may be automatically selected from the images 135 captured in the application event. Further, the name of the application event may be automatically registered in a tag of the image 135 captured in the application event, or a title incorporating the name of the application event may be automatically added to the created electronic album.

### Sixth Embodiment

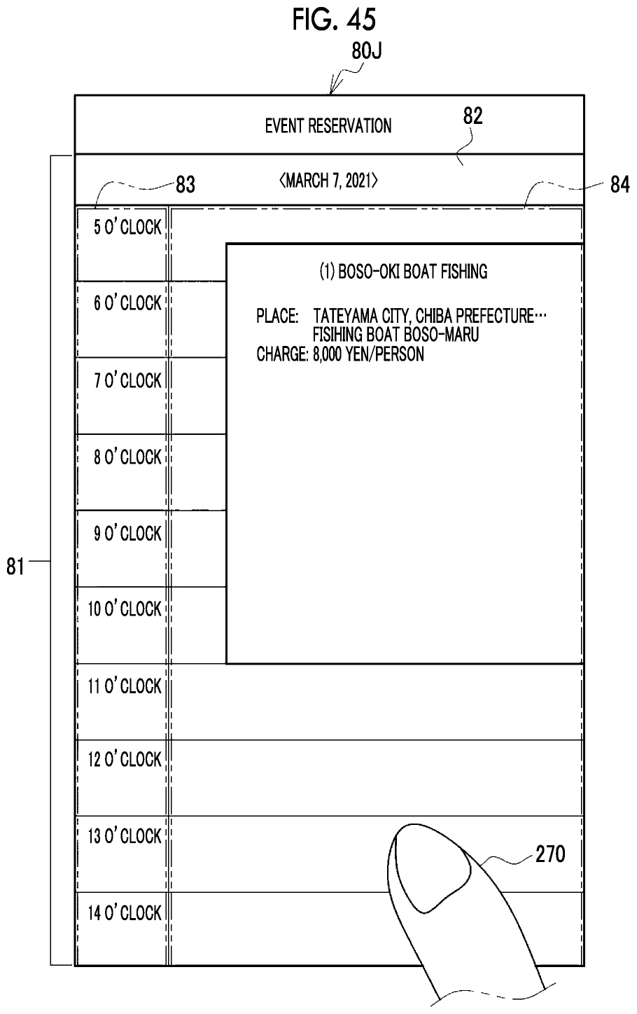

As shown in FIG. 45 as an example, in the information frame 84 of the schedule table 81 on a main screen 80J according to the present embodiment, a finger 270 can be used to select a free time in which the application event is not registered. In FIG. 45, the application event “Boso-oki boat fishing” is registered from 05:30 to 11:00, and the case where 13:00 of the free time is selected by the finger 270 is illustrated.

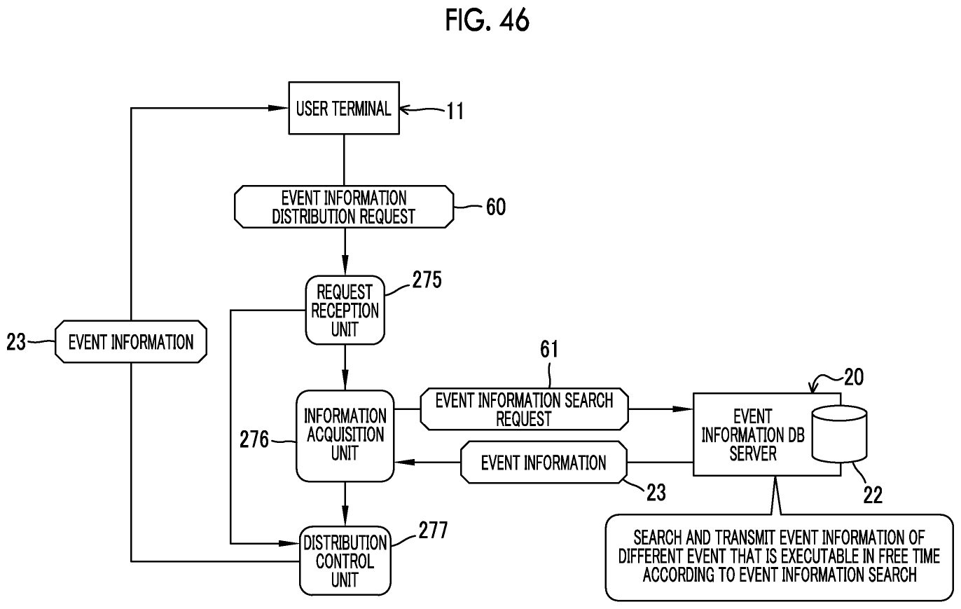

As shown in FIG. 46 as an example, a CPU (not shown) of the event reservation server according to the present embodiment functions as a request reception unit 275, an information acquisition unit 276, and a distribution control unit 277. In a case where the free time is selected, the user terminal 11 transmits the event information distribution request 60. The request reception unit 275 receives the event information distribution request 60 from the user terminal 11. The event information distribution request 60 is a content that requests the distribution of the event information 23 of the different event that is executable in the selected free time. The different event that is executable in the selected free time is specifically an event that is executed in a place within the distance range where the user can move, by the selected free time, from the place of the application event and can be started in the selected free time. That is, the event information distribution request 60 in this case is substantially the same as the different event information distribution request 170 according to the above 3_2 embodiment. The selection of the free time of the information frame 84 of the schedule table 81 with the finger 270 is substantially the same as selection of the different event display button 175 according to the above 3_2 embodiment.

The information acquisition unit 276 transmits the event information search request 61 according to the event information distribution request 60 to the event information DB server 20. The event information DB server 20 searches for the event information 23 of the different event that is executable in the selected free time, according to the event information search request 61, and transmits the searched event information 23 of the different event to the information acquisition unit 276. The information acquisition unit 276 acquires the event information 23 of the different event from the event information DB server 20. The information acquisition unit 276 outputs the acquired event information 23 of the different event to the distribution control unit 277. The distribution control unit 277 distributes the event information 23 of the different event to the user terminal 11, which is the transmission source of the event information distribution request 60.

As described above, in the sixth embodiment, it is possible to select the free time in the schedule table 81 and to request the presentation of the different event that is executable in the selected free time. Therefore, the user 13 can easily make the trip plan by a simple operation of selecting the free time in the schedule table 81.

The recommended event information 23 selected as in the second embodiment may be displayed in an area of the free time. In this case, it is preferable to change a background and/or a character color or the like to distinguish the recommended event information 23 from the event information 23 of the application event.

The image 135 such as a commemorative photo captured by an organizer side during the application event may be automatically distributed to the user terminal 11.

Various screens such as the main screen 80A may be generated in the event reservation server 10 and distributed to the user terminal 11 in a form of screen data for web distribution created by a markup language such as an extensible markup language (XML). The browser control unit 75 reproduces the various screens displayed on the web browser based on the screen data and displays the screens on the display 44B. Instead of XML, another data description language such as JavaScript (registered trademark) object notification (JSON) may be used.

The form of presenting the first additional information such as the route information 25 to the user 13 is not limited to the form of distributing the first additional information to the user terminal 11. The route information 25 or the like may be printed on a paper medium and the paper medium may be mailed to the user 13, or the route information 25 or the like may be attached to an e-mail and transmitted.

Various modification examples can be made for a hardware configuration of the computer constituting the event reservation server 10. For example, the event reservation server 10 may be composed of a plurality of computers separated as hardware for a purpose of improving processing capability and reliability. For example, two computers are responsible for, in a distributed manner, the functions of the request reception unit 55 and the distribution control unit 57 and the function of the information acquisition unit 56. In this case, the event reservation server 10 is configured by the two computers. Further, any one of the event reservation servers 10, 101, 131, or 191 and the various servers, such as the event information DB server 20, the route search server 21, the weather forecast server 102, and the image DB server 132, may be integrated into one server.

As described above, the hardware configuration of the computer of the event reservation servers 10 may be changed as appropriate according to required performance such as processing capability, safety, and reliability. Further, Not only the hardware but also the operation program 50 and the AP such as the event reservation AP 70, for the purpose of ensuring safety and reliability, may be duplicated or stored in a plurality of storage devices in a distributed manner. The user terminal 11 may be responsible for a part or all of the functions of each processing unit of the event reservation server 10.

In each of the above embodiments, for example, the following various processors can be used as the hardware structure of the processing unit that executes various pieces of processing, such as the request reception units 55, 105, 165, 200, and 275, the information acquisition units 56, 106, 166, 201, and 276, the distribution control units 57, 107, 167, 202, 255, 265, and 277, the browser control unit 75, and the image analysis unit 140. The various processors include a programmable logic device (PLD) which is a processor whose circuit configuration is changeable after manufacturing such as a field programmable gate array (FPGA) and/or a dedicated electric circuit which is a processor having a circuit configuration exclusively designed to execute specific processing such as an application specific integrated circuit (ASIC), and the like, in addition to the CPUs 42A and 42B which are general-purpose processors that execute software (operation program 50 and event reservation AP 70) to function as the various processing units.

One processing unit may be configured by one of the various types of processors or may be configured by a combination of two or more processors of the same type or different types (for example, a combination of a plurality of FPGAs and/or a combination of a CPU and an FPGA). The plurality of processing units may be composed of one processor.

As an example of configuring the plurality of processing units with one processor, first, there is a form in which one processor is configured by a combination of one or more CPUs and software and the processor functions as the plurality of processing units, as represented by computers such as a client and a server. Second, there is a form in which a processor that realizes the functions of the entire system including the plurality of processing units with one integrated circuit (IC) chip is used, as represented by a system-on-chip (SoC) or the like. As described above, the various processing units are configured using one or more of the various processors as the hardware structure.

More specifically, a circuitry combining circuit elements such as semiconductor elements may be used as the hardware structure of the various processors.

The above various embodiments and/or various modification examples can be combined as appropriate in the technique of the present disclosure. It is needless to say that the technique of the present disclosure is not limited to each of the above embodiments and various configurations can be employed without departing from the gist. Further, the technique of the present disclosure extends to a storage medium that stores the program non-transitorily, in addition to the program.

The description content and the illustrated content described above are detailed descriptions of portions according to the technique of the present disclosure and are merely an example of the technique of the present disclosure. For example, the above description of the configurations, functions, actions, and effects is an example of the configurations, functions, actions, and effects of the portions according to the technique of the present disclosure. Therefore, it is needless to say that an unnecessary part may be deleted, a new element may be added, or a replacement may be performed to the description content and the illustrated content described above within a scope not departing from the gist of the technique of the present disclosure. In order to avoid complication and facilitate understanding of the portion according to the technique of the present disclosure, the description related to common general knowledge not requiring special description in order to implement the technique of the present disclosure is omitted in the above description content and illustrated content.

In the present specification, “A and/or B” is synonymous with “at least one of A or B”. That is, “A and/or B” means that only A may be used, only B may be used, or a combination of A and B may be used. In the present specification, the same concept as “A and/or B” is also applied to a case where three or more matters are linked and expressed by “and/or”.

All documents, patent applications, and technical standards described in this specification are incorporated by reference in this specification to the same extent as in a case where the incorporation of each individual document, patent application, and technical standard by reference is specifically and individually described.

What is claimed is:

1. An information presentation device comprising:
a processor; and
a memory connected to or built into the processor,
wherein the processor
presents an event to a user,
receives a participation application for the event by the user,
acquires first additional information according to related information, which is related to an application event that is the event in which the user applies for participation, in a case where the related information is received from reception of the participation application for the application event to a start of the application event, and
presents the first additional information to the user.

2. The information presentation device according to claim 1,
wherein the related information is at least one of information related to a participation application by the user for an event different from the application event before the start of the application event or a weather forecast for a place of the application event on an event start day.

3. The information presentation device according to claim 2,
wherein the first additional information includes at least one of information related to a route between the place of the application event and a place of the different event or information on an alternative event in a case where the weather forecast is unsuitable for the application event.

4. The information presentation device according to claim 1,
wherein the event is selected based on an image owned by the user.

5. The information presentation device according to claim 1,
wherein the processor presents second additional information according to the application event to the user.

6. The information presentation device according to claim 5,
wherein the second additional information includes information on an item necessary for the application event.

7. The information presentation device according to claim 5,
wherein the second additional information includes information on a different event at a place within a distance range set in advance based on the place of the application event.

8. The information presentation device according to claim 5,
wherein the second additional information includes information on a place of meal where taking a meal is possible before or after the application event.

9. The information presentation device according to claim 5,
wherein the second additional information includes information on a way of enjoying the application event.

10. The information presentation device according to claim 5,
wherein the second additional information includes information on a recommended imaging point in the application event.

11. The information presentation device according to claim 1,
wherein the processor presents a reminder of the application event to the user.

12. The information presentation device according to claim 1,
wherein the processor
presents, to the user, notification to urge the user to upload an image captured in the application event after the application event is executed.

13. The information presentation device according to claim 1,
wherein a schedule table including the information on the application event is presented to the user.

14. The information presentation device according to claim 13,
wherein a free time is selectable in the schedule table, and
making a request for presentation of a different event that is executable in the selected free time is possible.

15. An operation method of an information presentation device, the method comprising:
presenting an event to a user;
receiving a participation application for the event by the user;
acquiring first additional information according to related information, which is related to an application event that is the event in which the user applies for participation, in a case where the related information is received from reception of the participation application for the application event to a start of the application event; and
presenting the first additional information to the user.

16. A non-transitory computer-readable storage medium storing an operation program of an information presentation device, the program causing a computer to execute a process comprising:
presenting an event to a user;
receiving a participation application for the event by the user;
acquiring first additional information according to related information, which is related to an application event that is the event in which the user applies for participation, in a case where the related information is received from reception of the participation application for the application event to a start of the application event; and
presenting the first additional information to the user.
